(19) United States
(12) Patent Application Publication
(10) Pub. No.: US 2026/0259846 A1
(43) Pub. Date: Sep. 3, 2026

(54) METHODS AND APPARATUS FOR A SERIAL LINK ADDRESSING SCHEME

(71) Applicant: Texas Instruments Incorporated, Dallas, TX (US)

(72) Inventors: Jayawardan Janardhanan, Bengaluru (IN); Mathews John, Bangalore (IN); Ravi Kiran Anantha Venkata Aripirala, Bengaluru (IN); Ravinder Sharma, Bangalore (IN)

(21) Appl. No.: 19/067,276

(22) Filed: Feb. 28, 2025

(51) Int. Cl. G06F 13/40; H04L 5/00; H04L 49/112; H04L 49/118

(52) U.S. Cl. CPC G06F 13/4022; H04L 5/0055; H04L 49/112; H04L 49/118

(57) ABSTRACT

An example apparatus includes programmable circuitry configured to identify a root device in a serial link network, the root device having a first output port, assign a first value as an address of the root device, identify a second device that is coupled to the first output port, the second device having a second output port and a third output port, assign a second value as the address of the second device, identify a third device and a fourth device, the third device coupled to the second output port and the fourth device coupled to the third output port, assign a third value as the address of the third device and a fourth value as the address of the fourth device, and provide the second value and the fourth value, which represents a routing range, at the first output port of the root device.

### TECHNICAL FIELD

This description relates generally to serial links and, more particularly, to methods and apparatus for a serial link addressing scheme.

### BACKGROUND

Complex automotive systems, such as automobiles, planes, and boats, include various electronic components that operate to benefit the user of the complex system. Such various electronic components may include cameras, digital video displays, processors, and a variety of sensors. A serial link network is a communication interface used in automotive systems to transport video, control data, and more from point to point (e.g., electronic component to electronic component). For example, the serial link network allows the various electronic components to exchange data with each other using serial communication. The serial communication is beneficial in complex automotive systems because it requires fewer communication channels relative to parallel communication and provides scalability to the automotive system, accommodating additional or fewer electronic components.

### SUMMARY

For applying an addressing scheme to a serial link network, an example apparatus includes interface circuitry, programmable circuitry configured to at least one of instantiate or execute machine-readable instructions to identify a root device in a serial link network, the root device having a first output port, assign a first value as an address of the root device, identify a second device in the serial link network that is coupled to the first output port of the root device, the second device having a second output port and a third output port, assign a second value as the address of the second device, identify a third device and a fourth device in the serial link network, the third device coupled to the second output port and the fourth device coupled to the third output port of the second device, assign a third value as the address of the third device and a fourth value as the address of the fourth device, and provide the second value and the fourth value, which represents a routing range, at the first output port of the root device. Other examples are described.

For applying the addressing scheme to the serial link network, example instructions cause one or more programmable circuits to identify a root device in a serial link network, the root device having a first output port, assign a first value as an address of the root device, identify a second device in the serial link network that is coupled to the first output port of the root device, the second device having a second output port and a third output port, assign a second value as the address of the second device, identify a third device and a fourth device in the serial link network, the third device coupled to the second output port and the fourth device coupled to the third output port of the second device, assign a third value as the address of the third device and a fourth value as the address of the fourth device, and provide the second value and the fourth value, which represents a routing range, at the first output port of the root device. Other examples are described.

For applying the addressing scheme to a serial link network, an example system includes a host device including programmable circuitry to configure an addressing scheme for the system, a deserializer coupled to the host device and having at least one output port, first and second intermediate devices connected in serial to the at least one output port, wherein the first and second intermediate devices have at least one output port and at least one input port, a first endpoint device coupled to the second intermediate device at one of the at least one output port of the second intermediate device, and wherein the programmable circuitry is configured to identify an order of the serially connected deserializer, first intermediate device, and second intermediate device from the host device to the first endpoint device and assign address values to the deserializer, first intermediate device, and second intermediate device based on the order, the address values to be used to generate an address range of the at least one output port of the deserializer. Other examples are described.

For using the addressing scheme in the serial link network, an example method includes identifying serializer circuitry connected to a sensor, determining an address of the serializer circuitry, identifying an output port of deserializer circuitry storing an address range including the address of the serializer circuitry, routing a message to the sensor through the output port. Other examples are described.

### BRIEF DESCRIPTION OF THE DRAWINGS

FIG. 1 is a block diagram of an example vehicle including an example advanced driver-assistance system (ADAS) and an example in-vehicle infotainment (IVI) system.

FIG. 2 is a block diagram of an example of the ADAS system of FIG. 1 including an example ADAS hub, an example peripheral module, and an example display, the ADAS hub further including example deserializer circuitry, and the peripheral module further including example serializer circuitry.

FIG. 3 is a block diagram of an example IVI system including example IVI driver circuitry, an example display driver, and an example display, the IVI driver circuitry including example serializer circuitry, and the display driver including example deserializer circuitry.

FIG. 4 is a block diagram of an example serial-deserializer (SerDes) system including an example of the serializer circuitry of FIGS. 2 and 3 and an example of the deserializer circuitry of FIGS. 2 and 3.

FIG. 5 is a block diagram of an example implementation of the programmable circuitry of one or more of the ADAS hub of FIG. 2 and the IVI driver circuitry of FIG. 3 including addressing scheme circuitry.

FIG. 6 is an example first serial link network illustrating a first implementation of the addressing scheme circuitry of FIG. 5 to assign address values and determine routing range(s).

FIG. 7 is an example second serial link network illustrating a second implementation of the addressing scheme circuitry of FIG. 5.

FIG. 8 is an example third serial link network illustrating a third implementation of the addressing scheme circuitry of FIG. 5 for multicasting.

FIG. 9 is a flowchart representative of example machine-readable instructions or example operations that may be at least one of executed, instantiated, or performed using an example programmable circuitry implementation of the addressing scheme circuitry of FIG. 5 to implement the third serial link network of FIG. 8.

FIG. 10 is an example fourth serial link network illustrating a fourth implementation of the addressing scheme circuitry of FIG. 5.

FIGS. 11 and 12 are a flowcharts representative of example machine-readable instructions or example operations that may be at least one of executed, instantiated, or performed using an example programmable circuitry implementation of the addressing scheme circuitry of FIG. 5 to implement the first serial link network of FIG. 6 or the fourth serial link network of FIG. 10.

FIG. 13 is an example fifth serial link network illustrating a fifth implementation of the addressing scheme circuitry of FIG. 5 and including an example network diagnostic analysis table.

FIG. 14 is a block diagram of an example processing platform including programmable circuitry structured to execute, instantiate, or perform the example machine-readable instructions or perform the example operations of FIGS. 9, 11, and 12 to implement the addressing scheme circuitry of FIG. 5.

FIG. 15 is a block diagram of an example software/firmware/instructions distribution platform (e.g., one or more servers) to distribute software, instructions, or firmware (e.g., corresponding to the example machine-readable instructions of FIGS. 9, 11, and 12) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

In a network of wire-connected devices, such as a serial link network, a control center (e.g., a host) addresses each device (e.g., electronic component), uniquely and individually or commonly as a group. For example, a host sends instructions to a first endpoint device (e.g., a sensor, a display, etc.) that may be separate from or the same as instructions sent to a second endpoint device. The network may include multiple components between the host and the endpoint device, each connected by serial link communication cables, such as Flat Panel Display (FPD) links. For example, the host is connected to the endpoint devices via a series of deserializers, serializers, and aggregators. In one example, the host is connected to a deserializer, the deserializer is connected to one or more aggregators via a serial link, and the one or more aggregators are connected to one or more serializers via another serial link, and the serializers are connected to an endpoint device (e.g., a camera, a display, a sensor, etc.). Generally, the serial link is the main data path between the host and the endpoint device that allows the host to communicate instructions to the endpoint device. Therefore, the host uses an addressing scheme that facilitates accurate and efficient communication between the host and endpoint devices.

Some creators of serial link networks use an addressing scheme that is inefficient. For example, some facilitators create addresses for endpoint devices based on (1) a depth of the device from the host and (2) exit ports of intermediate devices. The depth of the device is a value representative of a number of hops (e.g., links) between the host and the endpoint device. For example, a depth of “2” from a host to a camera indicates that the host is connected to a deserializer, the deserializer is connected to an aggregator, the aggregator is connected to a serializer, and the serializer is connected to a camera endpoint device. The depth is “2” because the number of serial links used is 2: one serial link connects the deserializer and the aggregator (first hop) and a second serial link connects the aggregator and the serializer (second hop). The exit ports of intermediate devices refer to a number assigned to ports of the deserializer, aggregator, and serializer. In some examples, intermediate devices, such as the deserializer, the aggregator, the serializer, etc., have two exit ports. For example, the deserializer has a first exit port “0” and a second exit port “1”, the aggregator has a first exit port “0” and a second exit port “1”, and the serializer has a first exit port “0” and a second exit port “1”.

This inefficient addressing scheme creates a destination address for a communication (e.g., a message) to an endpoint device (e.g., a camera) using the depth and exit port numbers in the form of an array. For example, the addressing scheme array may be: ([Depth], [exit port number at 1^{st} hop], [exit port number at 2^{nd} hop], [exit port number at 3^{rd} hop], [local or destination port number]). In such an example, the address from the host to a second camera may be (2,0,1,0,0), where two serial links (e.g., a depth of 2) are used between the host and the second camera, a first exit port [0] of the deserializer couples the deserializer to the aggregator, a second exit port [1] of the aggregator couples to the serializer, and a first exit port [0] of the serializer couples the serializer to the second camera.

This addressing scheme using depth and exit port numbers is inefficient because it is limited. In a serial link network, a cable is bidirectional and includes a back channel and a forward channel. The back channel is used to transfer lower bandwidth data, while the forward channel is used to carry high bandwidth video or sensor data. A first issue is that, depending on the device family, the forward channel frame size may vary from 28 bits to 40 bits, using 8b/10b style encoding for the back channel. 8b/10b style encoding is a line code that maps 8-bit words to 10-bit symbols. Therefore, the first issue is that the maximum number of bits that can be used for the address is 8, because the back channel of the serial link is used to transfer the addresses. This limits a number of hops that the addressing scheme can accommodate, because one bit is allotted per hop. For example, the maximum number of hops is 3. If the maximum number of hops is 3, that means that the maximum number of intermediate devices that can be used is 4, because 4 intermediate devices would require the address array to include 5 exit port numbers. Therefore, the total amount of bits used to address an endpoint device having a depth of 3 would be 8 bits. For example, 3+1+1+1+1+1+1=8.

A second issue is that this addressing scheme is direction sensitive, where the address can only be used for sending communications from the host to the endpoint device, and not from the endpoint device or some intermediate device back to the host. The addressing scheme is direction sensitive because exit port numbers are used in the address. In a reverse direction (e.g., from endpoint device to host processor), the exit ports of the forward direction become input ports in the reverse direction, and the input ports of the forward direction become the new exit ports in the reverse direction. Therefore, a different address would be needed for communication from the endpoint device to the host processor.

A third issue is that the address is modified at each hop in order to encode the source address in the message. The source address is encoded in the message to enable the endpoint device to send an acknowledgement back to the host processor. At each intermediate device, the message is updated with the depth and the input port coupled to the exit port sending the original message. Therefore, at each intermediate device, a cyclic redundancy check (CRC) calculation is evaluated. For example, because the message at each hop is updated with the depth and input port, the intermediate device has to check the message for any errors in data transmission.

Examples described herein provide addressing scheme circuitry that overcomes the above-described limitations. According to examples described here, the addressing scheme circuitry described herein assigns numerical values to nodes in an order (e.g., ascending or descending), then uses those values to create a contiguous address range for routing a communication to an endpoint device. For example, the addressing scheme circuitry causes a root node (e.g., a hub) to store an address range at each output port of the root node, where the address range indicates what nodes the hub can communicate with via that output port. In order to identify the address range, the addressing scheme circuitry recursively explores the nodes in the serial link network and assigns unused values to the nodes. In some examples, when those nodes are child nodes of the output port because they are coupled, either directly or indirectly, to the output port, the addressing scheme circuitry identifies the first of those nodes and the last of those nodes, and uses the address values assigned to the first and last node as the address range. For example, the address range includes a first address value in an order of serially connected intermediate devices, and a last address value in the order of serially connected intermediate devices, the last address value indicative of the parent intermediate device that is coupled to the last identified accessible endpoint device.

Examples described herein can accommodate any number of ports per device, or any number of hops in the serial link network. For example, the address range is only two values: the address of the first node coupled to the output port of root node and the address of the last node in a series of connections to the first node. Also, examples described herein support communication originating from any device to any device, making the address insensitive to the direction of communication, because the nodes (e.g., intermediate devices such as aggregators and serializers) are configured with parent ports (PP), which are default ports that are not assigned with an address or address range. Also, examples described herein do not update the message at each node and, thus, examples described herein require only the endpoint device to perform a CRC evaluation. For example, the address stays fixed throughout the entire message transmission and, thus, only the camera or sensor needs to evaluate any errors in data transmission. Performing only one CRC evaluation for every communication results in less resource utilization (e.g., less processing, less usage of memory, less usage of power, etc.) at the intermediate nodes.

Examples described herein also provide an improved mechanism for multicasting. Multicasting is a method of sending the same message or data from one source to multiple destinations simultaneously. Some methods of multicasting provide a routing table at the source device (e.g., source node, source hub, hub, etc.). The routing table stores information including the routing addresses from the source device to the target devices. The routing table informs the source device of where to send the message. A limitation related to storing a routing table at the source device is that the message is replicated at the source and each message is sent separately, occupying more of the serial link bandwidth. Another limitation related to storing a routing table at the source device is that the number of destination (e.g., target) devices is limited to the number of entries in the routing table.

The improved mechanism for multicasting described herein distributes multicast tables across the network at each device, where the multicast table is assigned a separate address relative to the destination addresses stored in the multicast table. Distributing the multicast tables across the network results in a shared path from source device to the intermediate device that stores the target multicast table. This shared path ensures that the network load is low by sending only one message in the shared path, then replicating the message at the target device and not replicating the message at the source.

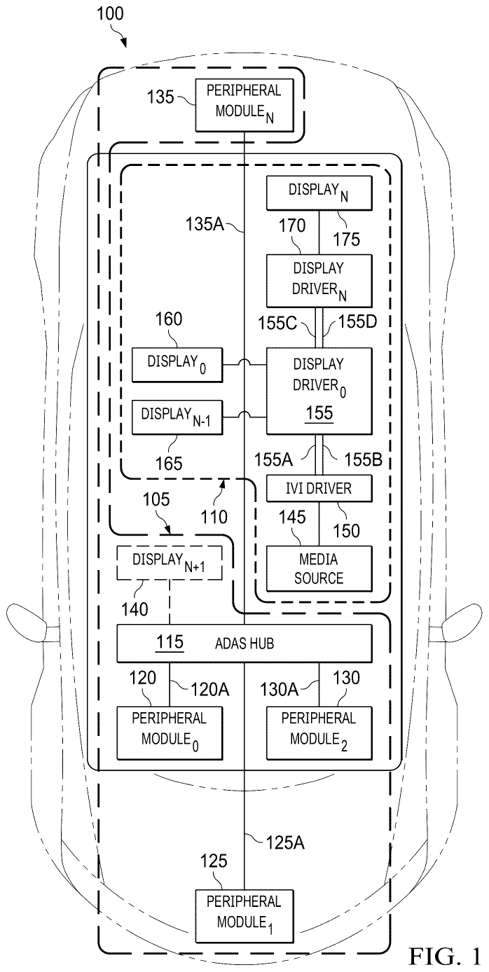

FIG. 1 is a block diagram of an example vehicle 100 including an example advanced driver-assistance (ADAS) system 105 and an example in-vehicle infotainment (IVI) system 110. The ADAS system 105 and the IVI system 110 may be referred to as flat panel display (FPD) link systems that may display media, such as images, multi-media content, etc. In some examples, the vehicle 100 may include one or more instances of the ADAS system 105 or the IVI system 110. For example, the vehicle 100 may include one or more instances of the ADAS system 105 without the IVI system 110. In another example, the vehicle 100 may include one or more instances of the IVI system 110 without the ADAS system 105. In yet another example, the vehicle 100 may include one or more instances of the ADAS system 105 and one or more instances of the IVI system 110. In the example of FIG. 1, the vehicle 100 is illustrated as a system for traversing distances, such as a car, a truck, etc. Alternatively, the vehicle 100 may be replaced, illustrated, or described as an alternative distributed display system, such as a boat, airplane, spacecraft, workstation, control panel, etc.

The ADAS system 105 of FIG. 1 includes an example ADAS hub 115, a first example peripheral module 120, a second example peripheral module 125, a third example peripheral module 130, a fourth example peripheral module 135, and an example display 140. Alternatively, the ADAS system 105 may include any number of peripheral module(s) or display(s).

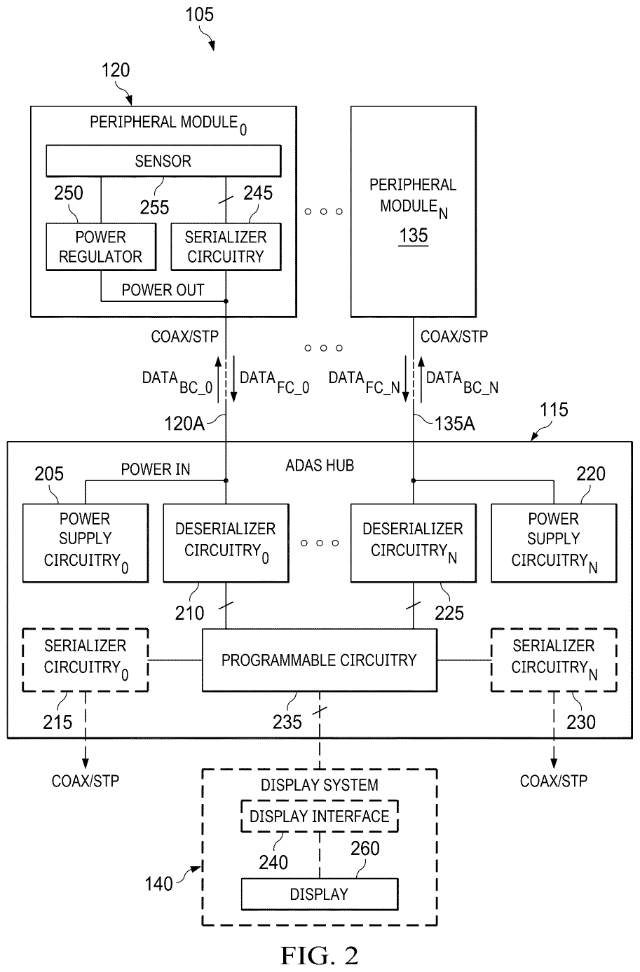

The ADAS system 105 is an example type of FPD-link system that utilizes serializing and deserializing data for driving assistance in the vehicle 100. In some examples, the ADAS system 105 utilizes serializing and deserializing media for an alternative implementation of processing, storing, or displaying data, such as a security system, recording system, etc. In some examples, the ADAS system 105 is an example camera system that facilitates at least one of the storing, processing, or displaying multi-media data (e.g., images, videos, etc.) from one or more sensors, such as cameras. In other examples, the ADAS system 105 may facilitate at least one of the storing, processing, or displaying an alternative type of data from one or more alternative types of sensors (e.g., lidar, radar, ultrasonic, etc.). An example of the ADAS system 105 is further illustrated and described in connection with FIG. 2.

The ADAS hub 115 is communicatively coupled to the peripheral modules 120, 125, 130, 135 and may be communicatively coupled to the display 140. The ADAS hub 115 uses full duplex communications to transmit data to and receive data from the peripheral modules 120, 125, 130, 135. In some examples, the ADAS hub 115 uses low-voltage differential signaling (LVDS) to communicate with the peripheral modules 120, 125, 130, 135. Alternatively, the ADAS hub 115 may use an alternative type of signaling to communicate with the peripheral modules 120, 125, 130, 135, such as display serial interface (DSI), embedded display port (eDP), etc. The ADAS hub 115 may at least one of store, process, or display data from the peripheral modules 120, 125, 130, 135. In the example of FIG. 1, the ADAS hub 115 may display the data from one or more of the peripheral modules 120, 125, 130, 135 using the display 140. In some examples, the ADAS system 105 does not implement the display 140. In some examples, when the ADAS system 105 implements the display 140, the ADAS hub 115 uses multi-lane signaling to display data using the display 140. Also, the ADAS hub 115 may also at least one of store or process data from the peripheral modules 120, 125, 130, 135 for other functions of the vehicle 100, such as object recognition, time of flight calculations, etc. An example of the ADAS hub 115 is further illustrated and described in connection with FIG. 2.

The peripheral modules 120, 125, 130, 135 are communicatively coupled to the ADAS hub 115. The peripheral modules 120, 125, 130, 135 include at least one sensor that receives information of the surrounding environment, such as images, videos, time of flight measurements, beamforming data, etc. The peripheral modules 120, 125, 130, 135 transmit the received sensor data to the ADAS hub 115 using communication channels 120A, 125A, 130A, 135A. In some examples, the communication channels 120A, 125A, 130A, 135A are coaxial connectors, which couple the ADAS hub 115 to the peripheral modules 120, 125, 130, 135. In such examples, the ADAS hub 115 supplies power to the peripheral modules 120, 125, 130, 135 using power over coax (POC) across the communication channels 120A, 125A, 130A, 135A. Alternatively, the communication channels 120A, 125A, 130A, 135A may be formed by a different type of connector, such as a standard twisted pair (STP). An example of the peripheral modules 120, 125, 130, 135 are further illustrated and described in connection with FIG. 2.

In example operation of the ADAS system 105 of FIG. 1, the peripheral modules 120, 125, 130, 135 produce video streams of the environment surrounding the vehicle 100. The peripheral modules 120, 125, 130, 135 serialize data of the video streams. The peripheral modules 120, 125, 130, 135 transmit the serial data streams to ADAS hub 115 using the communication channels 120A, 125A, 130A, 135A. Concurrently, the ADAS hub 115 may transmit data to the peripheral modules 120, 125, 130, 135 using the communication channels 120A, 125A, 130A, 135A. Communications between the ADAS hub 115 and the peripheral modules 120, 125, 130, 135 may occur simultaneously. Such multi-directional communications across the same one of the communication channels 120A, 125A, 130A, 135A are referred to as full duplex communications.

In such example operations of the ADAS system 105 of FIG. 1, the ADAS hub 115 receives the serial data streams from the peripheral modules 120, 125, 130, 135. The ADAS hub 115 deserializes the data streams to reconstruct the video streams captured by the peripheral modules 120, 125, 130, 135. The ADAS hub 115 at least one of stores, processes, or displays the video streams for driver assistance. For example, the ADAS hub 115 displays the video stream of the peripheral module 135 on the display 140 responsive to a determination that the perspective corresponding to the peripheral module 135 is needed. In another example, the ADAS hub 115 stores or process video streams of the peripheral modules 120, 125, 130, 135 for detecting safety hazards in the environment of the vehicle 100.

Example operations of the ADAS system 105 are further described in connection with FIG. 2. Advantageously, serializing and deserializing data from the peripheral modules 120, 125, 130, 135 reduces the number of connections within the vehicle 100 to the ADAS hub 115. Advantageously, the serial data streams are capable of accurately traversing relatively large distances across the communication channels 120A, 125A, 130A, 135A.

The IVI system 110 of FIG. 1 includes an example media source 145, example IVI driver circuitry 150, a first example display driver 155, a first example display 160, a second example display 165, a second example display driver 170, and a third example display 175. Alternatively, the IVI system 110 may include any number of display driver(s) or display(s).

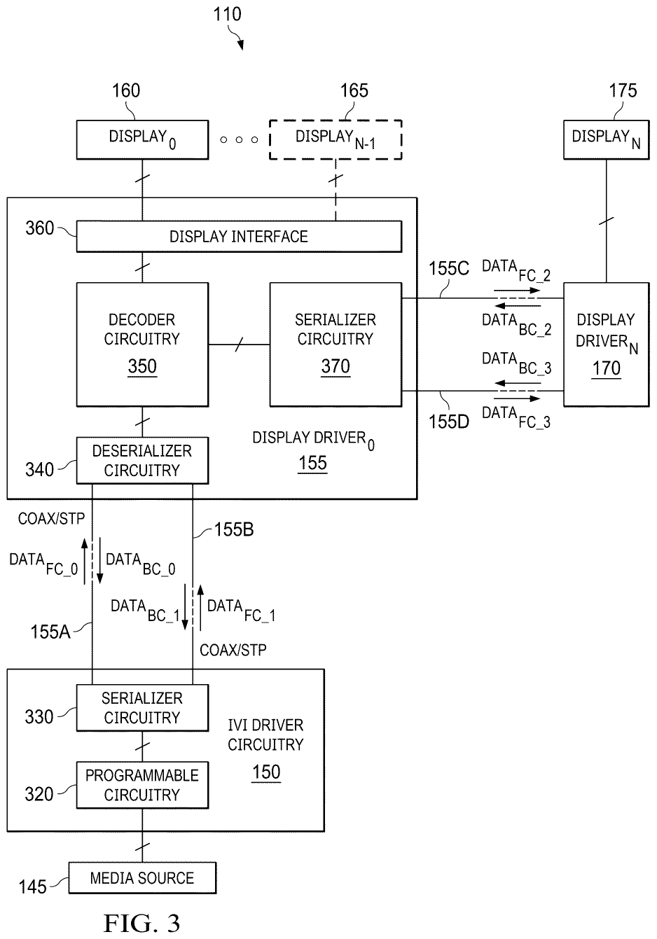

The IVI system 110 is an example type of FPD-link system that utilizes serializing and deserializing media for infotainment on one or more displays (e.g., the displays 160, 165, 175). In some examples, the IVI system 110 is a dashboard having multiple displays for displaying content. In other examples, the IVI system 110 is a different display system having multiple displays for displaying content, such as a studio, workstation, etc. In the example of FIG. 1, the IVI system 110 includes the media source 145, the IVI driver circuitry 150, the display drivers 155, 170, and the displays 160, 165, 175. Alternatively, the IVI system 110 may include any number of media source(s), display driver(s), or display(s). An example of the IVI system 110 is further illustrated and described in connection with FIG. 3.

In the IVI system 110, the media source 145 is coupled to the IVI driver circuitry 150. The media source 145 supplies media to the IVI driver circuitry 150 for display on one or more of the displays 160, 165, 175. In some examples, the media source 145 is integrated in the vehicle 100, such as circuitry supporting a data stream or memory storing media. In other examples, the media source 145 represents a connection to a device that is external to the vehicle 100, such as a wireless connection to a service hosting a multi-media stream.

The IVI driver circuitry 150 is communicatively coupled to the media source 145 and the display driver 155. The IVI driver circuitry 150 processes multi-media data from the media source 145 for transmission to one or more of the display drivers 155, 170. The IVI driver circuitry 150 uses full duplex communications to transmit data to and receive data from the display driver 155. In some examples, the IVI driver circuitry 150 uses LVDS to communicate with the display driver 155. In such examples, the IVI driver circuitry 150 indirectly communicates with the display driver 170 through the display driver 155. Such an example is further illustrated and described in connection with FIG. 3. Alternatively, the IVI driver circuitry 150 may use an alternative type of signaling to communicate with the display driver 155, such as DSI, eDP, etc. An example of the IVI driver circuitry 150 is further illustrated and described in connection with FIG. 3.

The display driver 155 is communicatively coupled to the IVI driver circuitry 150, the displays 160, 165, and the display driver 170. The display driver 155 interfaces with the IVI driver circuitry 150 using first and second communication channels 155A, 155B. The display driver 155 interfaces with the display driver 170 using third and fourth communication channels 155C, 155D. In the example of FIG. 1, first and second coaxial connectors form the communication channels 155A, 155B between the IVI driver circuitry 150 and the display driver 155. Similarly, third and fourth coaxial connectors form the communication channels 155C, 155D between the display drivers 155, 170. The display driver 155 uses multi-lane signaling to display media on the displays 160, 165. In some examples, the display driver 155 decodes additional data from the IVI driver circuitry 150 to determine which one of the displays 160, 165 corresponds to the data. Although the display driver 155 of FIG. 1 is coupled to the displays 160, 165, the display driver 155 may be coupled to any number of display(s). An example of the display driver 155 is further illustrated and described in connection with FIG. 3.

The display driver 170 is communicatively coupled to the display driver 155 and the display 175. In some examples, the display driver 170 may be coupled to another instance of the display driver 170 (similar to the communication channels 155A, 155B, 155C, 155D of the display driver 155). The display driver 170 interfaces with the display driver 155 using the communication channels 155C, 155D. The display driver 170 uses multi-lane signaling to display multi-media data using the display 175. Although the display driver 155 of FIG. 1 is coupled to the display 175, the display driver 170 may be coupled to any number of display(s).

In an example operation of the IVI system 110 of FIG. 1, the media source 145 supplies media for display on at least one of the displays 160, 165, 175. The IVI driver circuitry 150 determines one or more of the displays 160, 165, 175 to display the media from the media source 145. The IVI driver circuitry 150 determines which of the display drivers 155, 170 are coupled to the one or more of the displays 160, 165, 175. The IVI driver circuitry 150 generates an identifier(s) that specifies at least one of the one or more of the display drivers 155, 170 or one or more of the displays 160, 165, 175. The IVI driver circuitry 150 combines the identifying data and the media from the media source 145. The IVI driver circuitry 150 generates a serial data stream by serializing the combined data for transmission on at least one of the communication channels 155A, 155B.

In such example operations of the IVI system 110, the display driver 155 receives the serial data stream representing the media and identifying data. The display driver 155 deserializes the serial data stream(s) from the communication channels 155A, 155B. The display driver 155 decodes the identifying data to determine if the media corresponds to either of the displays 160, 165. If the display driver 155 determines that the media corresponds to one or more of the displays 160, 165, the display driver 155 displays the media on one or more of the displays 160, 165. If the display driver 155 determines that the media does not correspond to one or more of the displays 160, 165, the display driver 155 regenerates the serial data stream by reserializing the combined media and identifying data. The display driver 155 transmits the serial data to the display driver 170 via at least one of the communication channels 155C, 155D. After receiving the serial data stream from the communication channels 155C, 155D, the display driver 155 deserializes the serial data stream(s). The display driver 170 decodes the identifying data to determine if the media corresponds to the display 175. If the display driver 170 determines that the identifying data corresponds to the display 175, the display driver 170 displays the media on the display 175. In some examples, the display drivers 155, 170 transmit serial data along the communication channels 155A, 155B, 155C, 155D to the IVI driver circuitry 150. In such examples, the concurrent communications from the display drivers 155, 170 may confirm reception or display of the media on one or more of the displays 160, 165, 175.

Example operations of the IVI system 110 are further described in connection with FIG. 3. Serializing and deserializing media from the media source 145 reduces the number of connections to the displays 160, 165, 175 within the vehicle 100. Also, the serial data streams are capable of accurately traversing relatively large distances across the communication channels 155A, 155B, 155C, 155D.

FIG. 2 is a block diagram of an example of the ADAS system 105 of FIG. 1 including the ADAS hub 115, the peripheral modules 120, 135, and the display 140 of FIG. 1. The example ADAS hub 115 of FIG. 2 includes first example power supply circuitry 205, first example deserializer circuitry 210, first example serializer circuitry 215, second example power supply circuitry 220, second example deserializer circuitry 225, second example serializer circuitry 230, and example programmable circuitry 235. In FIG. 2, the example display 140 is a display system 140 and includes example display interface circuitry 240 and an example display 160. The example peripheral module 120 of FIG. 2 includes example serializer circuitry 245, example power regulator circuitry 250, and an example sensor 255.

The power supply circuitry 205 has an output coupled to the communication channel 120A and the deserializer circuitry 210. In some examples, the power supply circuitry 205 has an input coupled to a power storage or an electronic control unit (ECU), which supplies power. In other examples, the power supply circuitry 205 is in the peripheral module 120. In such examples, the power supply circuitry 205 directly supplies power to the peripheral module 120. Alternatively, a different method of powering the peripheral module 120 may be used with the circuitry described herein.

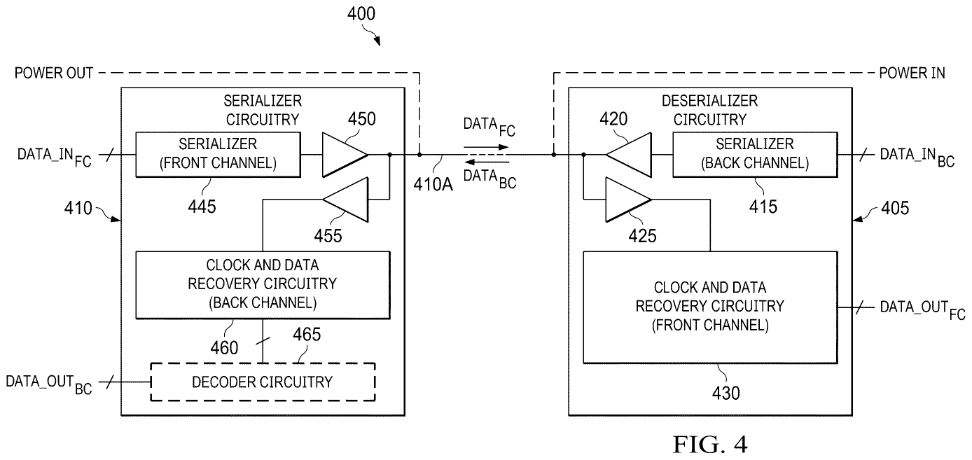

The deserializer circuitry 210 has an input and outputs. The input of the deserializer circuitry 210 is coupled to the communication channel 120A and the power supply circuitry 205. The outputs of the deserializer circuitry 210 are coupled to the serializer circuitry 215 and the programmable circuitry 235. In some examples, the deserializer circuitry 210 communicates with the peripheral module 120 using serial data streams along the communication channel 120A. An example of the deserializer circuitry 210 is further illustrated and described in connection with FIG. 4.

The serializer circuitry 215 has inputs and an output. The inputs of the serializer circuitry 215 are coupled to the deserializer circuitry 210 and the programmable circuitry 235. The output of the serializer circuitry 215 is structured to be coupled to an additional communication channel. In some examples, as illustrated by the dashed lines, the ADAS hub 115 may include the serializer circuitry 215 to connect the ADAS system 105 to external circuitry. In such examples, the serializer circuitry 215 may communicatively couple the ADAS system 105 to another ADAS system, the IVI system 110, storage medium, an ECU, etc. In other examples, the serializer circuitry 215 may be excluded from the ADAS hub 115.

The power supply circuitry 220 has an output coupled to the communication channel 135A and the deserializer circuitry 225. In some examples, the power supply circuitry 220 has an input coupled to a power storage or an ECU, which supplies power. In other examples, the power supply circuitry 220 is in the peripheral module 135. In such examples, the power supply circuitry 220 directly supplies power to the peripheral module 135. Alternatively, a different method of powering the peripheral module 135 may be used with the circuitry described herein.

The deserializer circuitry 225 has an input and outputs. The input of the deserializer circuitry 225 is coupled to the communication channel 135A and the power supply circuitry 220. The outputs of the deserializer circuitry 225 are coupled to the serializer circuitry 230 and the programmable circuitry 235. In some examples, the deserializer circuitry 225 communicates with the peripheral module 135 using serial data streams along the communication channel 135A. An example of the deserializer circuitry 225 is further illustrated and described in connection with FIG. 4.

The serializer circuitry 230 has inputs and an output. The inputs of the serializer circuitry 230 are coupled to the deserializer circuitry 225 and the programmable circuitry 235. The output of the serializer circuitry 230 is structured to be coupled to an additional communication channel. In some examples, as illustrated by the dashed lines, the ADAS hub 115 may include the serializer circuitry 230 to connect the ADAS system 105 to external circuitry. In such examples, the serializer circuitry 230 may communicatively couple the ADAS system 105 to another ADAS system, the IVI system 110, storage medium, an ECU, etc. In other examples, the serializer circuitry 230 may be excluded from the ADAS hub 115.

The programmable circuitry 235 has first inputs, second inputs, and outputs. The first inputs of the programmable circuitry 235 are coupled to the deserializer circuitry 210 and the serializer circuitry 215. The second inputs of the programmable circuitry 235 are coupled to the deserializer circuitry 225 and the serializer circuitry 230. In some examples, the outputs of the programmable circuitry 235 are coupled to the display interface circuitry 240. In some examples, the programmable circuitry 235 instantiates circuitry responsive to an execution of machine-readable instructions. In such examples, the programmable circuitry 235 may be one of a central processing unit (CPU), a graphic processing unit (GPU), multi-core processing unit (MCU), etc. Alternatively, the programmable circuitry 235 may be an application specific integrated circuit (ASIC) structured to at least one of store, process, or condition data from the deserializer circuitry 210, 225.

The ADAS system 105 may include the display system 140. The display interface circuitry 240 has inputs and outputs. The inputs of the display interface circuitry 240 are coupled to the programmable circuitry 235. The outputs of the display interface circuitry 240 are coupled to the display 260. In some examples, the display interface circuitry 240 represents a display driver, which converts data from the programmable circuitry 235 to drive the display 260. In some such examples, the display interface circuitry 240 may include a port and connector specific for driving the display 260, such as a display port, a high-definition multimedia interface (HDMI) port, etc.

The serializer circuitry 245 has inputs and an output. The inputs of the serializer circuitry 245 are coupled to the sensor 255. In some examples, the inputs of the serializer circuitry 245 are coupled to a camera serial interface (CSI), which is connected to the output of the sensor 255. The output of the serializer circuitry 245 is coupled to the communication channel 120A and the power regulator circuitry 250. In some examples, the serializer circuitry 245 communicates with the ADAS hub 115 using serial data streams along the communication channel 120A. An example of the serializer circuitry 245 is further illustrated and described in connection with FIG. 4.

In the example of FIG. 2, the deserializer circuitry 210 is communicatively coupled to the serializer circuitry 245 by a full duplex wireline connection represented by the communication channel 120A. In some examples, both the deserializer circuitry 210 and the serializer circuitry 245 may receive data from or transmit data on the communication channel 120A. In such examples, the input of the deserializer circuitry 210 and the output of the serializer circuitry 245 are bi-directional. Such an example is further described in connection with FIG. 4.

The power regulator circuitry 250 has an input and an output. The input of the power regulator circuitry 250 is coupled to the communication channel 120A and the serializer circuitry 245. The output of the power regulator circuitry 250 is coupled to the sensor 255. The power regulator circuitry 250 receives power from the power supply circuitry 205. In some examples, such as in FIG. 2, the power regulator circuitry 250 receives power through the communication channel 120A. In other examples, the power supply circuitry 205 may be coupled to the power regulator circuitry 250 by a separate connection or positioned in proximity to the peripheral module 120.

The sensor 255 has an input and outputs. The input of sensor 255 is coupled to the power regulator circuitry 250. The outputs of the sensor 255 are coupled to the serializer circuitry 245. In some examples, the sensor 255 produces data corresponding to a surrounding environment. For example, in FIG. 1, the sensor 255 may be a camera positioned to capture a portion of the environment surrounding the vehicle 100. In another example, the sensor 255 may be an alternative type of sensor for corresponding to characteristics of the surrounding environment of the vehicle 100, such as obstacles.

In example operation, the power supply circuitry 205 supplies power to the power regulator circuitry 250 through the communication channel 120A. In some examples, such as the communication channel 120A being a coaxial connector, the power supply circuitry 205 and the power regulator circuitry 250 implement power over coax (POC). In such examples, the power supply circuitry 205 supplies power (POWER IN) and the power regulator circuitry 250 receives power (POWER OUT). The power regulator circuitry 250 powers the sensor 255, or more generally the peripheral module 120 based on power from the power supply circuitry 205. Similarly, the power supply circuitry 220 may utilize the communication channel 135A to supply power to the peripheral module 135.

The sensor 255 generates data corresponding to the surrounding environment. In some examples, the sensor 255 is a camera that produces multimedia data corresponding to a perspective of the surrounding environment. In another example, the sensor 255 is a lidar device that produces time of flight data corresponding to potential obstacles in the surrounding environment. In yet another example, the sensor 255 is a radar that produces beamforming data corresponding to the surrounding environment. Alternatively, the sensor 255 may be an alternative type of sensor that produces an alternative type of data. In such example operations, the sensor 255 produces sensor data using multiple parallel data paths (also referred to as lines or lanes). The serializer circuitry 245 serializes data of the multiple parallel data paths to produce a serial data stream having a data rate greater than the data rate of the parallel data paths from the sensor 255. The serializer circuitry 245 transmits the serial data stream to the deserializer circuitry 210 using a front channel of the communication channel 120A. Such data of the serial data stream is referred to as front channel data (DATA_{FC_0}).

In example operation, the deserializer circuitry 210 receives the serial data stream after traversing the communication channel 120A. Concurrently, the deserializer circuitry 210 may transmit a serial data stream to the serializer circuitry 245 using a back channel of the communication channel 120A. Such data is referred to as back-channel data (DATA_{BC_0}). In such examples, the front channel data has a data rate greater than the back-channel data to reduce interference. Such multi-directional communications along the communication channel 120A are referred to as full-duplex communications. The deserializer circuitry 210 may use the back channel of the communication channel 120A to control settings of the sensor 255 or verify reception of data on the front channel. Similarly, the peripheral module 135 and the deserializer circuitry 225 may utilize full-duplex communications along the communication channel 135A to exchange front and back-channel data (DATA_{FC_N}, DATA_{BC_N}).

In example operation, the deserializer circuitry 210 deserializes the front channel data to produce multiple parallel data paths. In some examples, the deserializer circuitry 210 may decode identifying data from the front channel data. In such examples, the serializer circuitry 215 may serialize and transmit the front channel data to external circuitry responsive to the deserializer circuitry 210 decoding identifying data corresponding to external circuitry. Advantageously, the serializer circuitry 215 allows the ADAS system 105 to be coupled to another instance of the ADAS system 105, the IVI system 110, or alternative type of data processing system.

In example operation, the programmable circuitry 235 at least one of processes, stores, or conditions the data of the multiple parallel data paths for the display system 140. In some examples, the programmable circuitry 235 combines data from the peripheral modules 120, 135 prior to display. For example, the programmable circuitry 235 may stitch video streams from the peripheral modules 120, 135 to display a larger portion of the surrounding environment. In such examples, the display interface circuitry 240 structures the data from the programmable circuitry 235 to drive the display 260. In some examples, the display interface circuitry 240 is at least one of a column pixel driver or a row pixel driver. The display 260 produces a perceivable representation of the data from at least one of the peripheral modules 120, 135.

Example operations of the serializer and deserializer system of the ADAS system 105 are further described in connection with FIG. 4. Advantageously, serializing and deserializing data from the peripheral modules 120, 135 reduces the number of connections to the ADAS hub 115. Advantageously, the serial data streams are capable of accurately traversing relatively large distances across the communication channels 120A, 135A.

FIG. 3 is a block diagram of an example of the IVI system 110 of FIG. 1. The IVI system 110 of FIG. 3 includes the media source 145, the IVI driver circuitry 150, the example of the display driver 155, 170, and the displays 160, 165, 175 of FIG. 1. The example IVI driver circuitry 150 of FIG. 3 includes example programmable circuitry 320 and example serializer circuitry 330. The example display driver 155 of FIG. 3 includes example deserializer circuitry 340, example decoder circuitry 350, example display interface circuitry 360, and example serializer circuitry 370.

The programmable circuitry 320 has an input and outputs. The input of the programmable circuitry 320 is coupled to the media source 145. The outputs of the programmable circuitry 320 are coupled to the serializer circuitry 330. In some examples, the programmable circuitry 320 instantiates circuitry responsive to the execution of machine-readable instructions. In such examples, the programmable circuitry 320 may be one of a CPU, a GPU, an MCU, etc. Alternatively, the programmable circuitry 320 may be an ASIC structured to at least one of store, process, or condition data from the media source 145. In some examples, the programmable circuitry 235 and programmable circuitry 320 are implemented by the same hardware. For example, the programmable circuitry 235 and programmable circuitry 320 may be parts and/or portions of a single integrated circuit. As such, programmable circuitry 235 and programmable circuitry 320 are connected, such that the ADAS hub 115 and the IVI driver circuitry 150 are in communication with each other. For example, the ADAS hub 115 can communicate with the display driver 155 through programmable circuitry 235, and the IVI driver circuitry 150 can communicate with the peripheral module 120 through programmable circuitry 320.

The serializer circuitry 330 has inputs, a first output, and a second output. The inputs of the serializer circuitry 330 are coupled to the programmable circuitry 320. The first output of the serializer circuitry 330 is coupled to the communication channel 155A. The second output of the serializer circuitry 330 is coupled to the communication channel 155B. In some examples, the serializer circuitry 330 communicates with the display driver 155 using serial data streams along the communication channels 155A, 155B. An example of the serializer circuitry 330 is further illustrated and described in connection with FIG. 4. Unlike the serializer circuitry 245 of FIG. 2, the serializer circuitry 330 exchanges data using multiple serial data streams along the communication channels 155A, 155B. In some examples, the serializer circuitry 330 may be illustrated and described as a plurality of instances of the serializer circuitry 330 supporting a single one of the communication channels 155A, 155B. For example, the serializer circuitry 330 may be separated into two instances of the serializer circuitry 330.

The deserializer circuitry 340 has a first input, a second input, and outputs. The first input of the deserializer circuitry 340 is coupled to the communication channel 155A. The second input of the deserializer circuitry 340 is coupled to the communication channel 155B. The outputs of the deserializer circuitry 340 are coupled to the decoder circuitry 350. In some examples, the deserializer circuitry 340 communicates with the IVI driver circuitry 150 using serial data streams along the communication channels 155A, 155B. An example of the deserializer circuitry 340 is further illustrated and described in connection with FIG. 4. Unlike the deserializer circuitry 210, 225 of FIG. 2, the deserializer circuitry 340 exchanges data using multiple serial data streams along the communication channels 155A, 155B. In some examples, the deserializer circuitry 340 may be illustrated and described as a plurality of instances of the deserializer circuitry 340 supporting a single one of the communication channels 155A, 155B. For example, the deserializer circuitry 340 may be separated into two instances of the deserializer circuitry 340, such as the deserializer circuitry 210, 225 of FIG. 2.

The decoder circuitry 350 has inputs, first outputs, and second outputs. The inputs of the decoder circuitry 350 are coupled to the deserializer circuitry 340. The first outputs of the decoder circuitry 350 are coupled to the display interface 360. The second outputs of the decoder circuitry 350 are coupled to the serializer circuitry 370. In some examples, the decoder circuitry 350 is implemented using programmable circuitry or an ASIC. In such examples, the decoder circuitry 350 is structured to route data from the deserializer circuitry 340 to at least one of the display interface 360 or the serializer circuitry 370 responsive to the decoded portions of the data. Such portions of the data from the deserializer circuitry 340 may be referred to as identifying data, which specifies one or more of the displays 160, 165, 175 to display the media on.

The display interface 360 has inputs, first outputs, and second outputs. The inputs of the display interface 360 are coupled to the decoder circuitry 350. The first outputs of the display interface 360 are coupled to the display 160. The second outputs of the display interface 360 are coupled to the display 165. In some examples, the display interface 360 drives one or more of the displays 160, 165 responsive to data from the decoder circuitry 350. In some such examples, the display interface 360 may include a port and connector specific for driving the displays, such as a display port, an HDMI port, etc. In the example of FIG. 3, the display interface 360 drives the displays 160, 165. Alternatively, the display driver 155 may include any number of display interfaces 360 for driving any number of displays, such as the displays 160, 165.

The serializer circuitry 370 has inputs, a first output, and a second output. The inputs of the serializer circuitry 370 are coupled to the decoder circuitry 350. The first output of the serializer circuitry 370 is coupled to the communication channel 155C. The second output of the serializer circuitry 370 is coupled to the communication channel 155D. In some examples, the serializer circuitry 370 communicates with the display driver 170 using serial data streams along the communication channels 155C, 155D. An example of the serializer circuitry 370 is further illustrated and described in connection with FIG. 4. Similar to the serializer circuitry 330, the serializer circuitry 370 exchanges data using multiple serial data streams along the communication channels 155C, 155D. In some examples, the serializer circuitry 370 may be illustrated and described as a plurality of instances of the serializer circuitry 370 supporting one of the communication channels 155C, 155D. For example, the serializer circuitry 370 may be separated into two instances of the serializer circuitry 370.

In example operation, the programmable circuitry 320 receives multimedia data from the media source 145. In some examples, the media source 145 is internal to the IVI system 110, such as memory storage, an ECU, a media stream, etc. In other examples, the media source 145 is external to the IVI system 110, such as a wireless connection to a service hosting a multi-media stream. The programmable circuitry 320 identifies one or more of the displays 160, 165, 175 that correspond to the data from the media source 145. In some examples, the programmable circuitry 320 encodes additional data onto the data from the media source 145 corresponding to different operations of the IVI system 110. For example, the programmable circuitry 320 adds identifying data into portions of the data from the media source 145 to specify one or more of the displays 160, 165, 175 that correspond to the media. In such examples, the identifying data may specify the one or more of the displays 160, 165, 175. The programmable circuitry 320 supplies the data to the serializer circuitry 330 for transmission to the display drivers 155, 170.

In example operation, the serializer circuitry 330 receives data from the programmable circuitry 320 on multiple parallel data paths. The serializer circuitry 330 serializes data of the multiple parallel data paths to produce a first and second serial data stream having a data rate greater than the data rate of the parallel data paths from the programmable circuitry 320. The serializer circuitry 330 transmits the first serial data stream to the deserializer circuitry 340 using a front channel of the communication channel 155A. The data of the first serial data stream is referred to as first front channel data (DATA_{FC_0}). The serializer circuitry 330 transmits the second serial data stream to the deserializer circuitry 340 using a front channel of the communication channel 155B. The data of the second serial data stream is referred to as second front channel data (DATA_{FC_1}). Advantageously, increasing the number of communication channels between the serializer circuitry 330 and the deserializer circuitry 340 increases the possible number of displays the IVI system 110 may support at a given time.

In example operation, the deserializer circuitry 340 receives the first and second serial data streams after traversing the communication channels 155A, 155B. Concurrently, the deserializer circuitry 340 may transmit a first serial data stream to the serializer circuitry 330 using a back channel of the communication channel 155A. The data of the first serial data stream is referred to as first back-channel data (DATA_{BC_0}). Similarly, the deserializer circuitry 340 may transmit a second serial data stream to the serializer circuitry 330 using a back channel of the communication channel 155B. The data of the second serial data stream is referred to as second back-channel data (DATA_{BC_1}). In such examples, the first and second front channel data has a data rate greater than the first and second back-channel data to reduce interference. Such multi-directional communications along the communication channels 155A, 155B are referred to as full-duplex communications. The deserializer circuitry 340 may use the back channel of the communication channels 155A, 155B to verify reception of the first and second front channel data, report errors to the programmable circuitry 320, etc. Similarly, the display driver 170 and the serializer circuitry 370 may utilize full-duplex communications along the communication channels 155C, 155D to exchange third and fourth front channel data (DATA_{FC_2}, DATA_{FC_3}) and third and fourth back-channel data (DATA_{BC_2}, DATA_{BC_3}).

In an example operation, the deserializer circuitry 340 deserializes the first and second front channel data to produce multiple parallel data paths. The decoder circuitry 350 decodes the data from the media source 145 from the additional data from the programmable circuitry 320. The decoder circuitry 350 determines which one or more of the displays 160, 165, 175 correspond to the data from the media source 145 responsive to the decoded data. In some examples, the decoder circuitry 350 supplies the multiple parallel data paths to the serializer circuitry 370 responsive to a determination that the media does not correspond to the displays 160, 165. In such examples, the serializer circuitry 370 serializes and transmits the third and fourth front channel data to the display driver 170. Advantageously, the display driver 170 may be coupled in series with another instance of the display driver 170 by additional communication channels, such as a fifth and sixth communication channel.

In example operation, the decoder circuitry supplies the multiple parallel data paths to the display interface 360 responsive to a determination that the media from the media source 145 corresponds to at least one of the displays 160, 165. In some examples, the display interface 360 structures the data from the decoder circuitry 350 to drive one or more of the displays 160, 165. In some examples, the display interface 360 is at least one of a column pixel driver or a row pixel driver. In such examples, at least one of the displays 160, 165 produce a perceivable representation of the media from the media source 145 responsive to the display interface 360.

Example operations of the serializer and deserializer system of the IVI system 110 are further described in connection with FIG. 4. Advantageously, serializing and deserializing data from the media source 145 reduces the number of connections to one or more of the displays 160, 165, 175. Also, the serial data streams are capable of accurately traversing relatively large distances across the communication channels 155A, 155B, 155C, 155D.

FIG. 4 is a block diagram of an example serial-deserializer (SerDes) system 400 including example deserializer circuitry 405 and example serializer circuitry 410. The example deserializer circuitry 405 of FIG. 4 includes an example serializer 415, example transmitter circuitry 420, example receiver circuitry 425, and example clock and data recovery (CDR) circuitry 430. The example serializer circuitry 410 of FIG. 4 includes an example serializer 445, example transmitter circuitry 450, example receiver circuitry 455, example CDR circuitry 460, and example decoder circuitry 465.

The SerDes system 400 includes an interface between the deserializer circuitry 405 and the serializer circuitry 410 in both the ADAS system 105 of FIGS. 1 and 2 and the IVI system 110 of FIGS. 1 and 3. In the example of the ADAS system 105 of FIG. 2, the deserializer circuitry 405 represents the deserializer circuitry 210 in the ADAS hub 115 and the serializer circuitry 410 represents the serializer circuitry 245 in the peripheral module 120. In the example of the IVI system 110 of FIG. 3, the deserializer circuitry 405 represents the deserializer circuitry 340 in the display driver 155. Also, in the example of the IVI system 110 of FIG. 3, the serializer circuitry 410 represents the serializer circuitry 330 in the IVI driver circuitry 150 or the serializer circuitry 370 in the display driver 155.

The deserializer circuitry 405 is coupled to the serializer circuitry 410 by the communication channel 410A. The deserializer circuitry 405 has inputs (DATA_IN_{BC}) and outputs (DATA_OUT_{FC}). The inputs and outputs of the deserializer circuitry 405 are structured to be coupled to one of the programmable circuitry 235 of FIG. 2 or the decoder circuitry 350 of FIG. 3. The inputs of the deserializer circuitry 405 receive back-channel data for transmission along the communication channel 410A. The outputs of the deserializer circuitry 405 provide front channel data from the communication channel 410A.

The serializer circuitry 410 is coupled to the deserializer circuitry 405 by the communication channel 410A. The serializer circuitry 410 has inputs (DATA_IN_{FC}) and outputs (DATA_OUT_{BC}). The inputs and outputs of the serializer circuitry 410 are structured to be coupled to one of the sensor 255 of FIG. 2 or the programmable circuitry 320 of FIG. 3. The inputs of the serializer circuitry 410 receive front channel data for transmission along the communication channel 410A. The outputs of the serializer circuitry 410 provide back-channel data from the communication channel 410A.

The serializer 415 has inputs and an output. The inputs of the serializer 415 are coupled to the inputs of the deserializer circuitry 405 (DATA_IN_{BC}). The output of the serializer 415 is coupled to the transmitter circuitry 420. In some examples, the serializer 415 is referred to as a back-channel serializer.

The transmitter circuitry 420 has an input and an output. The input of the transmitter circuitry 420 is coupled to the serializer 415. The output of the transmitter circuitry 420 is coupled to the communication channel 410A and the receiver circuitry 425. In some examples, the transmitter circuitry 420 is referred to as a back-channel transmitter.

The receiver circuitry 425 has an input and an output. The input of the receiver circuitry 425 is coupled to the communication channel 410A and the transmitter circuitry 420. The output of the receiver circuitry 425 is coupled to the CDR circuitry 430. In some examples, the receiver circuitry 425 is referred to as a front channel receiver.

The CDR circuitry 430 has an input and outputs. The input of the CDR circuitry 430 is coupled to the receiver circuitry 425. The outputs of the CDR circuitry 430 are coupled to the outputs of the deserializer circuitry 405 (DATA_OUT_{FC}). In some examples, the CDR circuitry 430 is referred to as front channel CDR circuitry.

The serializer 445 has inputs and an output. The inputs of the serializer 445 are coupled to the inputs of the serializer circuitry 410 (DATA_IN_{FC}). The output of the serializer 445 is coupled to the transmitter circuitry 450. In some examples, the serializer is referred to as a front channel serializer.

The transmitter circuitry 450 has an input and an output. The input of the transmitter circuitry 450 is coupled to the serializer 445. The output of the transmitter circuitry 450 is coupled to the communication channel 410A and the receiver 455. In some examples, the transmitter circuitry 450 is referred to as a front channel transmitter. The transmitter circuitry 420, 450 may include circuitry to impedance match the communication channel 410A to reduce reflections. Also, the transmitter circuitry 420, 450 may have different bandwidths.

The receiver circuitry 455 has an input and an output. The input of the receiver circuitry 455 is coupled to the communication channel 410A and the transmitter circuitry 450. The output of the receiver circuitry 455 is coupled to the CDR circuitry 460. In some examples, the receiver circuitry 455 is referred to as a back-channel receiver.

The CDR circuitry 460 has an input and outputs. The input of the CDR circuitry 460 is coupled to the receiver circuitry 455. The outputs of the CDR circuitry 460 are coupled to the decoder circuitry 465. In some examples, the CDR circuitry 460 is referred to as back-channel CDR circuitry.

The decoder circuitry 465 has inputs and outputs. The inputs of the decoder circuitry 465 are coupled to the CDR circuitry 460. The outputs of the decoder circuitry 465 are coupled to the outputs of the serializer circuitry 410 (DATA_OUT_{BC}). In some examples, as illustrated by the dashed lines, the outputs of the CDR circuitry 460 are directly coupled to the outputs of the serializer circuitry 410 (DATA_OUT_{BC}).

In example operation, the deserializer circuitry 405 receives back-channel data (DATA_{BC}) via multiple data paths from an external data source, such as the programmable circuitry 235 or the decoder circuitry 350. The serializer 415 produces a back-channel serial data stream responsive to the back-channel data. The transmitter circuitry 420 transmits the back-channel data to the serializer circuitry 410 across the communication channel 410A. Similarly, the serializer circuitry 410 receives front channel data (DATA_{FC}) via multiple data paths from an external data source, such as the sensor 255 or the programmable circuitry 320. The serializer 445 produces a front channel serial data stream responsive to the front channel data. The transmitter circuitry 420 transmits the front channel data to the deserializer circuitry 405 across the communication channel 410A. In some examples, the data rates of the transmissions of the front and back-channel data are different to prevent interference. In some examples, the bandwidth of the transmitter circuitry 420, which transmits the back-channel data, is modified to reduce non-linear gain contributions of the communication channel 410A. Advantageously, the serializers 415, 445 and the transmitter circuitry 420, 450 support full-duplex data transmissions along the communication channel 410A.

In an example operation, the deserializer circuitry 405 receives the front channel data (DATA_{FC}) after propagating along the communication channel 410A. The receiver circuitry 425 produces a serial data stream representing the front channel data responsive to signals from the communication channel 410A. In some examples, the receiver circuitry 425 isolates the communication channel 410A from the CDR circuitry 430. The deserializer circuitry 405 may include echo cancelation circuitry to reduce contributions of the back-channel data from signals received by the transmitter circuitry 420. Similarly, the serializer circuitry 410 receives the back-channel data (DATA_{BC}) after propagating along the communication channel 410A. The receiver circuitry 455 produces a serial data stream representing the back-channel data responsive to signals from the communication channel 410A. In some examples, the receiver circuitry 425 isolates the communication channel 410A from the CDR circuitry 430. The serializer circuitry 410 may include echo cancelation circuitry to reduce contributions of the front channel data from signals received by the transmitter circuitry 450. Also, the receiver circuitry 425, 455 terminate currents of the communication channel 410A.

In an example operation, the CDR circuitry 430 receives the front channel data from the receiver circuitry 425. The CDR circuitry 430 retimes the front channel data to produce retimed front channel data. The CDR circuitry 430 produces a clock signal, which represents an accurate sampling time of the retimed front channel data. The CDR circuitry 430 produces multiple parallel data paths representing the front channel data. The outputs of the deserializer circuitry 405 provide the front channel data to external circuitry, such as the programmable circuitry 235 or the decoder circuitry 350. Similarly, the CDR circuitry 460 receives the back-channel data from the receiver circuitry 455. The CDR circuitry 460 produces retimed back-channel data and a clock signal responsive to the retiming of the back-channel data to the clock signal. The CDR circuitry 460 produces multiple parallel data paths representing the back-channel data. In some such example operations, the decoder circuitry 465 decodes portions of the back-channel data prior to the outputs of the serializer circuitry 410 supplying the back-channel data to external circuitry, such as the sensor 255 or the programmable circuitry 320.

Advantageously, serializing and deserializing front and back-channel data reduces the number of connections that need to traverse relatively large distances of the communication channel 410A. Advantageously, the serial data streams are capable of accurately traversing relatively large distances across the communication channels 410A.

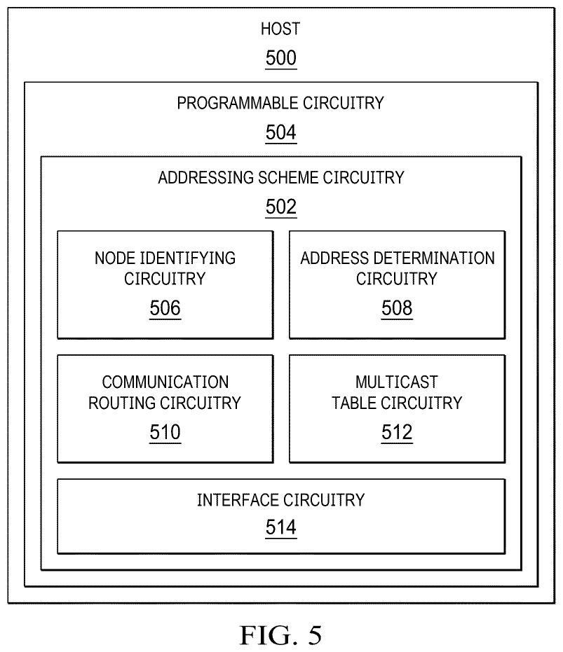

FIG. 5 is a block diagram of an example host 500 in which example addressing scheme circuitry 502 operates to identify address ranges for endpoint devices in a serial link network, such as the advanced driver-assistance (ADAS) system 105 or the in-vehicle infotainment (IVI) system 110 of FIGS. 1-3. In FIG. 5, the example host 500 includes example programmable circuitry 504. The example host 500 may be implemented by any one of the ADAS hub 115 or the IVI driver circuitry 150 and, thus, the example programmable circuitry 504 may be implemented by programmable circuitry 235 or programmable circuitry 320, respectively. The example addressing scheme circuitry 502 of FIG. 5 may be instantiated (e.g., creating an instance of, bring into being for any length of time, materialize, implement, etc.) by programmable circuitry such as a Central Processor Unit (CPU) executing first instructions. Also, the addressing scheme circuitry 502 of FIG. 5 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 5 may, thus, be instantiated at the same or different times. Some or all of the circuitry of FIG. 5 may be instantiated, for example, in one or more threads executing concurrently on hardware or in series on hardware. Moreover, in some examples, some or all of the circuitry of FIG. 5 may be implemented by microprocessor circuitry executing instructions or FPGA circuitry performing operations to implement one or more virtual machines or containers.

In some examples, the addressing scheme circuitry 502 may be implemented by deserializer circuitry, aggregator circuitry, or serializer circuitry. For example, the addressing scheme circuitry 502 may be implemented by each device in the serial link network (e.g., the ADAS system 105 or the IVI system 110).

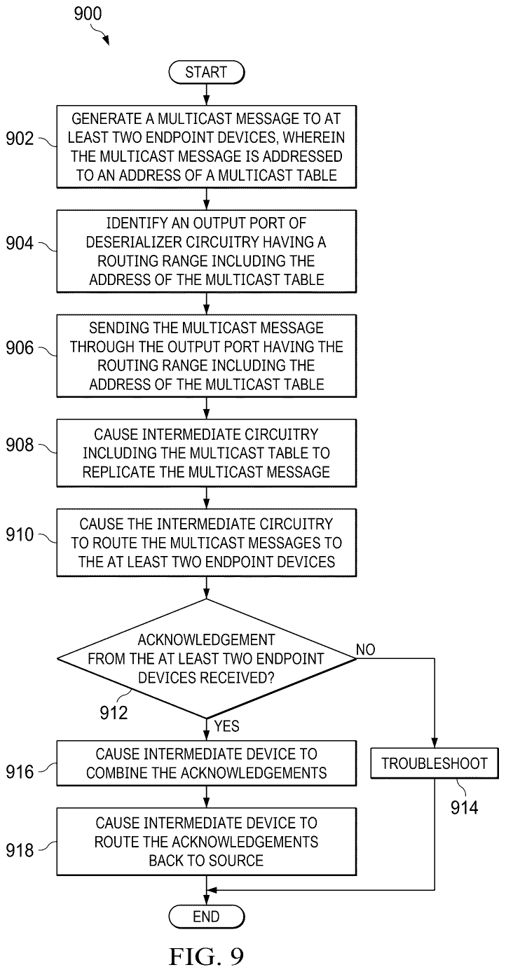

The addressing scheme circuitry 502 includes example node identifying circuitry 506, example address determination circuitry 508, example communication routing circuitry 510, example multicast table circuitry 512, and example interface circuitry 514. In some examples, the node identifying circuitry 506 is instantiated by programmable circuitry executing node identifying instructions to perform operations such as those represented by the flowcharts of FIGS. 9, 11, and 12. In some examples, the address determination circuitry 508 is instantiated by programmable circuitry executing address determination instructions to perform operations such as those represented by the flowcharts of FIGS. 9, 11, and 12. In some examples, the communication routing circuitry 510 is instantiated by programmable circuitry executing communication routing instructions to perform operations such as those represented by the flowcharts of FIGS. 9, 11, and 12. In some examples, the multicast table circuitry 512 is instantiated by programmable circuitry executing multicast table instructions to perform operations such as those represented by the flowcharts of FIGS. 9, 11, and 12. In some examples, the interface circuitry 514 is instantiated by programmable circuitry executing interface circuitry instructions to perform operations such as those represented by the flowcharts of FIGS. 9, 11, and 12.

In FIG. 5, the addressing scheme circuitry 502 includes the node identifying circuitry 506 to identify devices and their respective connections (e.g., wired connections, serial link connections, FPD link connections, cables, etc.) in a given serial link network. In some examples, the connections are the communication channels 120A, 125A, 130A, 135A, 155A, 155B, 155C, 155D. In some examples, the devices include displays 160, 165, 175 of FIG. 1, first deserializer circuitry 210, first serializer circuitry 215, second deserializer circuitry 225, second serializer circuitry 230, serializer circuitry 245, sensor 255 of FIG. 2, serializer circuitry 330, deserializer circuitry 340, and serializer circuitry 370 of FIG. 3, and the deserializer circuitry 405 and serializer circuitry 410 of FIG. 4. Also, the devices include aggregator circuitry, not illustrated in FIGS. 1-4 above. Aggregator circuitry is implemented between deserializer circuitry and serializer circuitry in situations where the ADAS hub 115 or the IVI driver circuitry 150 are located long distances away in the vehicle 100 from the peripheral modules 120, 125, 130 or displays 160, 165, 170. In some examples, it is not ideal for the length of the communication channels to exceed a threshold length due to cost and design. Therefore, aggregator circuitry is added to the ADAS system 105 or the IVI system 110 to reduce the length of the communication channels. The aggregator circuitry may act as a signal distributor between serializer circuitry and deserializer circuitry. Also, the aggregator circuitry acts as a signal processor to combine or process signals to and from the serializer circuitry and deserializer circuitry.

The node identifying circuitry 506 identifies the devices based on generating an acyclic graph of the serial link network. For example, the node identifying circuitry 506 abstracts a representation of devices and respective connections in the serial link network. The representation includes nodes representative of the devices and edges representative of the connections. The node identifying circuitry 506 uses the acyclic graph (e.g., the representation) to identify root nodes and child nodes.

As used herein, a root node typically refers to deserializer circuitry, such as the deserializer circuitry 210 or 225 of FIG. 2, deserializer circuitry 340 of FIG. 3, or deserializer circuitry 405 of FIG. 4. The root node refers to deserializer circuitry because the addressing scheme circuitry 502 operates to identify a routing address from a host (e.g., ADAS hub 115 of FIG. 1, IVI driver circuitry 150 of FIG. 1, programmable circuitry 235 of FIG. 2, programmable circuitry 320 of FIG. 3, etc.) to an endpoint device (e.g., displays 160, 165, and 175 of FIGS. 1 and 3, sensor 255 of FIG. 2, camera, etc.). Therefore, the deserializer circuitry in the acyclic graph represents the beginning or starting point in a series of connections of devices from the host to the endpoint device.

As used herein, a child node may refer to any intermediate circuitry, such as aggregator circuitry such or serializer circuitry (e.g., serializer circuitry 245 of FIG. 2, serializer circuitry 370 of FIG. 3, or serializer circuitry 410 of FIG. 4). The child node may refer to aggregator circuitry or serializer circuitry because any of the aggregator circuitry or the serializer circuitry may be directly connected to the root node (e.g., the deserializer circuitry). In the series of connections of devices in the serial link network, the aggregator circuitry and serializer circuitry receive data from the deserializer circuitry and, thus, are positioned after the root node in the acyclic graph.

In some examples, the node identifying circuitry 506 uses the acyclic graph to identify parent nodes. As used herein, the parent nodes refer to any node which is a predecessor of any child node. For example, the root node (e.g., the deserializer circuitry) may also be a first parent node to a first child node (e.g., first aggregator circuitry), the first child node may be identified as a second parent node to a second child node (e.g., second aggregator circuitry), and the second child node may be identified as a third parent node to a third child node (e.g., first serializer circuitry). A parent node can have any number of child nodes. For example, the third parent node (e.g., second aggregator circuitry) may be connected to the third child node (e.g., first serializer circuitry) and a fourth child node (e.g., second serializer circuitry).

The node identifying circuitry 506 identifies a hierarchy of nodes, starting with root nodes, then parent nodes, and lastly child nodes. The hierarchy of nodes can be used to determine an order of devices (e.g., nodes) which data propagates through, from host to a particular endpoint device. The order of devices can be used to assign addresses to the devices. For example, the node identifying circuitry 506 informs address determination circuitry 508 of an order of connections of the devices, which can be used to assign values in ascending or descending order, relative to the order of devices.

To determine the order of devices or the route of data packets, the node identifying circuitry 506 selects an output port of a root node to analyze. The nodes (e.g., devices) can include a plurality of output ports. For example, the deserializer circuitry may have one or more Inter-Integrated Circuit (I²C) ports, one or more Serial Peripheral Interface (SPI) ports, one or more general-purpose input/output (GPIO) ports, etc. The node identifying circuitry 506 selects one of the output ports, and follows the output connection to the next node to identify the child node connected to that output port. In some examples, if the node identifying circuitry 506 determines that the child node has a plurality of output ports, the node identifying circuitry 506 selects one to analyze and, once an endpoint device has been found, analyzes the next output port of that child node. For example, the aggregator circuitry may have one or more Inter-Integrated Circuit (I²C) ports, one or more Serial Peripheral Interface (SPI) ports, one or more general-purpose input/output (GPIO) ports, etc. The node identifying circuitry 506 recursively explores the nodes in the serial link network to determine an order of the devices.

In some examples, the node identifying circuitry 506 identifies devices and determines an order of the devices based on sending ping tests from the host. For example, the node identifying circuitry 506 generates a ping traceroute test, which causes a host to send a data packet to a specific IP address of an endpoint device and waits for a response. If a response is received, the node identifying circuitry 506 can verify whether intermediate devices exists in the network. For example, the ping traceroute test is like a collection of ping requests strung together to determine the exact path between a source (e.g., host) and destination (e.g., endpoint device). The ping traceroute test tracks each hop the packets take along the route and, thus, track each intermediate device the packets go through. The node identifying circuitry 506 may use the response of the ping traceroute test to identify the order of devices from host to the endpoint device.

In FIG. 5, the addressing scheme circuitry 502 includes the address determination circuitry 508 to determine a value to assign as an address of a device. The address determination circuitry 508 assigns the value as the address of the devices based on the order of the devices identified by the node identifying circuitry 506. For example, the address determination circuitry 508 uses a pre-defined sequence of values to assign to the devices based on the order of the devices, such as {0, 1, 2, 3, . . . N} or {N . . . 3, 2, 1, 0}. The address determination circuitry 508 may assign addresses in an ascending order as and when new devices are identified by the node identifying circuitry 506. For example, the address determination circuitry 508 begins assigning addresses by initializing a variable “value” to equal a first number in the pre-defined number sequence (e.g., value=0). When the node identifying circuitry 506 identifies the root node, the address determination circuitry 508 assigns the address of the root node to equal the value, and then increments the value. The address determination circuitry 508 increments the value in preparation for the next identified node. For example, after assigning the value to the root node, the address determination circuitry 508 increments value (e.g., value++; value=1), assigns the address of the next identified node to equal the value, and then increments the value again. The address determination circuitry 508 exhausts a value as a candidate for a subsequent address of a device in the serial link network when the value is assigned as an address of a previous device.

The address determination circuitry 508 continues to assign addresses to nodes (e.g., devices) as the node identifying circuitry 506 identifies and determines the order of nodes from root to endpoint. Once node identifying circuitry 506 exhausts the ports of a child node, the address determination circuitry 508 stores the addresses that are accessible through the ports in the connecting port of its parent device. For example, output ports (e.g., the connecting port where an address is stored) have memory that can be used to store data, such as an address or address range. The address determination circuitry 508 stores one or two address values in memory of the output port of the parent node, where the address values are representative of the addresses of the child nodes that are connected to the output ports. In some examples, if an output port has more than one child node, the address determination circuitry 508 stores two address values in the parent node output port. For example, the address determination circuitry 508 stores an address range, including the address of the first child node and the address of the last child node in which the output port of the parent node is connected to. In some examples, if an output port has one child node, the address determination circuitry 508 stores one address value in the output port.

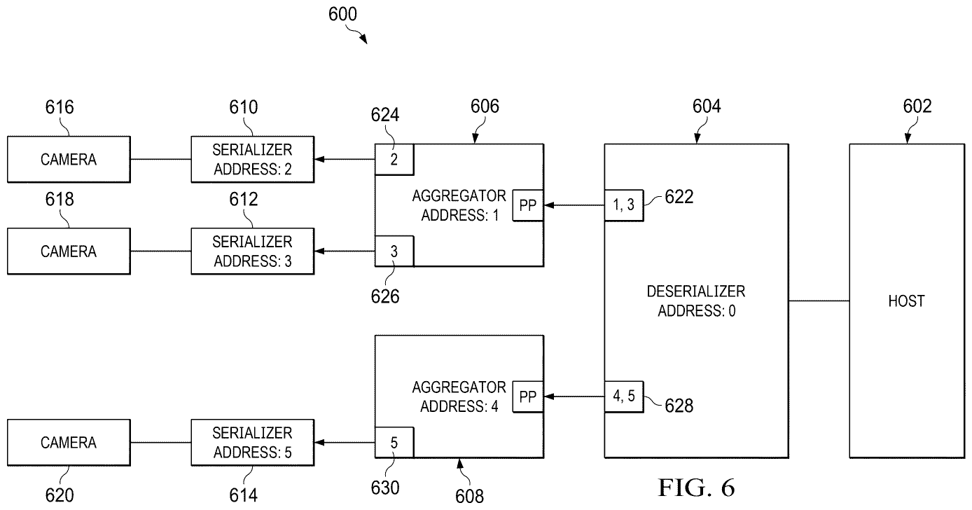

Turning to FIG. 6, an example first serial link network 600 is illustrated. The first serial link network 600 depicts a first implementation of the addressing scheme program of the node identifying circuitry 506 and address determination circuitry 508 of the addressing scheme circuitry 502 of FIG. 5. For example, the first serial link network 600 depicts example devices (e.g., nodes) having addresses and storing address values and ranges in output ports. In FIG. 6, the first serial link network 600 includes an example host 602, an example deserializer circuitry 604, example first aggregator circuitry 606, example second aggregator circuitry 608, example first serializer circuitry 610, example second serializer circuitry 612, example third serializer circuitry 614, an example first camera 616, an example second camera 618, and an example third camera 620.

In the addressing scheme program, the node identifying circuitry 506 identifies the host 602, the deserializer circuitry 604, the first aggregator 606, the second aggregator 608, the first serializer 610, the second serializer 612, the third serializer 614, the first camera 616, the second camera 618, and the third camera 620 based on generating an acyclic graph of the first serial link network 600 or based on sending ping traceroute tests from the host 602. The node identifying circuitry 506 uses the acyclic graph or the response from the ping traceroute to determine that the root node is the deserializer circuitry 604. The address determination circuitry 508 assigns “Address: 0” to the deserializer circuitry 604, responsive to the node identifying circuitry 506 determining that the deserializer circuitry 604 is the root node.

In the addressing scheme program, the node identifying circuitry 506 selects an example first output port 622 of the root node to analyze/follow. For example, the node identifying circuitry 506 selects a first one of the two output ports of the deserializer circuitry 604 and identifies the devices that are directly and indirectly connected to the first output port 622. The node identifying circuitry 506 determines that the child node of the deserializer circuitry 604 is the first aggregator 606. For example, the node identifying circuitry 506 determines that the first aggregator 606 is connected to the deserializer circuitry 604 at the first output port 622. In some examples, a serial link (e.g., an FPD link) connects the first aggregator 606 to the deserializer circuitry 604. The address determination circuitry 508 assigns “Address: 1” to the first aggregator 606, responsive to the node identifying circuitry 506 determining that the first aggregator 606 is the child node to the deserializer circuitry 604.

In the addressing scheme program, the node identifying circuitry 506 selects an example second output port 624 of the first aggregator 606 to analyze/follow. For example, the node identifying circuitry 506 selects a first one of the two output ports of the first aggregator 606 and identifies the devices that are directly and indirectly connected to the second output port 624. The node identifying circuitry 506 determines that the child node of the first aggregator 606 is the first serializer 610. For example, the node identifying circuitry 506 determines that the first serializer 610 is connected to the first aggregator 606 at the second output port 624. In some examples, a serial link connects the first aggregator 606 to the first serializer 610. The address determination circuitry 508 assigns “Address: 2” to the first serializer 610, responsive to the node identifying circuitry 506 determining that the first serializer 610 is the child node to the first aggregator 606.

In the addressing scheme program, the node identifying circuitry 506 determines that the first serializer 610 is connected directly to an endpoint device. For example, the node identifying circuitry 506 determines that the first camera 616 is connected to the output of the first serializer 610, and no child nodes are identifiable between the first serializer 610 and the first camera 616. The address determination circuitry 508 stores address value “2” in the second output port 624 of the first aggregator 606, responsive to the node identifying circuitry 506 exhausting the devices connected to the second output port 624.

In the addressing scheme program, the node identifying circuitry 506 selects an example third output port 626 of the first aggregator 606 to analyze/follow. For example, the node identifying circuitry 506 selects a second one of the two output ports of the first aggregator 606 and identifies the devices that are directly and indirectly connected to the third output port 626. The node identifying circuitry 506 selects the third output port 626 of the first aggregator 606 rather than another output port of the deserializer circuitry 604 to analyze because the node identifying circuitry 506 is to find and identify all the devices accessible via the first output port 622 before moving on to the other output port of the deserializer circuitry 604. By identifying and assigning addresses this way, an address range can be determined for the first output port 622. The node identifying circuitry 506 determines that a second child node of the first aggregator 606 is the second serializer 612. For example, the node identifying circuitry 506 determines that the first serializer 610 is connected to the second aggregator 608 at the third output port 626. In some examples, a serial link connects the first aggregator 606 to the second serializer 612. The address determination circuitry 508 assigns “Address: 3” to the second serializer 612, responsive to the node identifying circuitry 506 determining that the second serializer 612 is a child node to the first aggregator 606.

In the addressing scheme program, the node identifying circuitry 506 determines that the second serializer 612 is connected directly to an endpoint device. For example, the node identifying circuitry 506 determines that the second camera 618 is connected to the output of the second serializer 612, and no child nodes are identifiable between the second serializer 612 and the second camera 618. The address determination circuitry 508 stores address value “3” in the third output port 626 of the first aggregator 606, responsive to the node identifying circuitry 506 exhausting the devices connected to the third output port 626.

In the addressing scheme program, the node identifying circuitry 506 determines that the output ports of the first aggregator 606 have been exhausted or analyzed. The address determination circuitry 508 stores an address range at the first output port 622 of the deserializer circuitry 604. For example, the address determination circuitry 508 stores address range “1-3” in memory at the first output port 622, indicating that the host 602 can access devices 1, 2, and 3 (e.g., first aggregator 606, first serializer 610, and second serializer 612) from the first output port 622 of the deserializer circuitry 604.

The node identifying circuitry 506 selects an example fourth output port 628 to analyze responsive to the address determination circuitry 508 storing the address range “1-3” in memory at the first output port 622. For example, the node identifying circuitry 506 selects a second one of the two output ports of the deserializer circuitry 604 and identifies the devices that are directly and indirectly connected to the fourth output port 628. The node identifying circuitry 506 determines that a second child node of the deserializer circuitry 604 is the second aggregator 608. For example, the node identifying circuitry 506 determines that the second aggregator 608 is connected to the deserializer circuitry 604 at the fourth output port 628. In some examples, a serial link connects the second aggregator 608 to the deserializer circuitry 604. The address determination circuitry 508 assigns “Address: 4” to the second aggregator 608, responsive to the node identifying circuitry 506 determining that the second aggregator 608 is a child node to the deserializer circuitry 604. Once a number is used, the address determination circuitry 508 does not reuse the number as an address value. Therefore, the address determination circuitry 508 does not reset or restart a number sequence when a new port of the root node is analyzed.

In the addressing scheme program, the node identifying circuitry 506 selects an example fifth output port 630 of the second aggregator 608 to analyze/follow. For example, the node identifying circuitry 506 selects the one output port of the second aggregator 608 and identifies the devices that are directly and indirectly connected to the fifth output port 630. The node identifying circuitry 506 determines that the child node of the second aggregator 608 is the third serializer 614. For example, the node identifying circuitry 506 determines that the third serializer 614 is connected to the second aggregator 608 at the fifth output port 630. In some examples, a serial link connects the second aggregator 608 to the third serializer 614. The address determination circuitry 508 assigns “Address: 5” to the third serializer 614, responsive to the node identifying circuitry 506 determining that the third serializer 614 is the child node to the second aggregator 608.

In the addressing scheme program, the node identifying circuitry 506 determines that the third serializer 614 is connected directly to the third camera 620. The address determination circuitry 508 stores address value “5” in memory of the fifth output port 630 of the second aggregator 608, responsive to the node identifying circuitry 506 exhausting the devices connected to the fifth output port 630.

In the addressing scheme program, the node identifying circuitry 506 determines that the output port of the second aggregator 606 has been exhausted or analyzed. The address determination circuitry 508 stores an address range at the fourth output port 628 of the deserializer circuitry 604. For example, the address determination circuitry 508 stores address range “4-5” in memory at the fourth output port 628, indicating that the host 602 can access devices 4 and 5 (e.g., second aggregator 608 and third serializer 614) from the fourth output port 628 of the deserializer circuitry 604.

Returning to FIG. 5, the addressing scheme circuitry 502 includes the communication routing circuitry 510 to route messages from the host to an intended (e.g., target) endpoint device using the addressing scheme. In some examples, the communication routing circuitry 510 is triggered by the programmable circuitry 504 in response to user input. For example, when a user of an automotive vehicle puts the vehicle in reverse, the programmable circuitry 504 triggers the communication routing circuitry 510 to route a message to a rear camera to turn on. In some examples, the communication routing circuitry 510 is triggered by the programmable circuitry 504 in response to updated configuration information or control parameters. For example, the programmable circuitry 504 specify a specific area within the sensor's field of view to focus on and, thus, trigger the communication routing circuitry 510 to route a message to the target sensor indicative to adjust the field of view. The communication routing circuitry 510 routes messages, instructions, data packets, etc. to the endpoint devices (e.g., camera, sensor, display, etc.).

The communication routing circuitry 510 routes messages to a target endpoint device based on identifying the serializer circuitry connected to the target endpoint devices. The communication routing circuitry 510 identifies the serializer circuitry in order to determine the address of the serializer circuitry. The communication routing circuitry 510 uses the address of the connecting serializer circuitry to identify an output port of the deserializer circuitry to send the message through. For example, the communication routing circuitry 510 identifies an output port of the deserializer circuitry storing an address range (e.g., routing range) including the address of the serializer circuitry. For example, when the host 602 (FIG. 6) configures a message to be sent to the first serializer 610 (FIG. 6), the communication routing circuitry 510 determines that the first serializer 610 has an address “2”. The communication routing circuitry 510 uses address “2” to identify which output port of the deserializer circuitry 604 (FIG. 6) has access to address “2”. The communication routing circuitry 510 determines that the first output port 622 (FIG. 6) includes memory storing an address range (e.g., 1-3) including the address of the first serializer 610 (Address: 2).

The communication routing circuitry 510 may route messages through a parent port of intermediate circuitry in response to the deserializer circuitry not storing an address range including the address of the target serializer circuitry. For example, when the serial link system (e.g., vehicle 100) includes two or more deserializers, the programmable circuitry 504 may randomly select deserializer circuitry to send information from, and that deserializer circuitry may not have connection access to the target serializer circuitry. The parent port of a connected intermediate device can be utilized to route a message to the target, but disconnected, serializer circuitry.

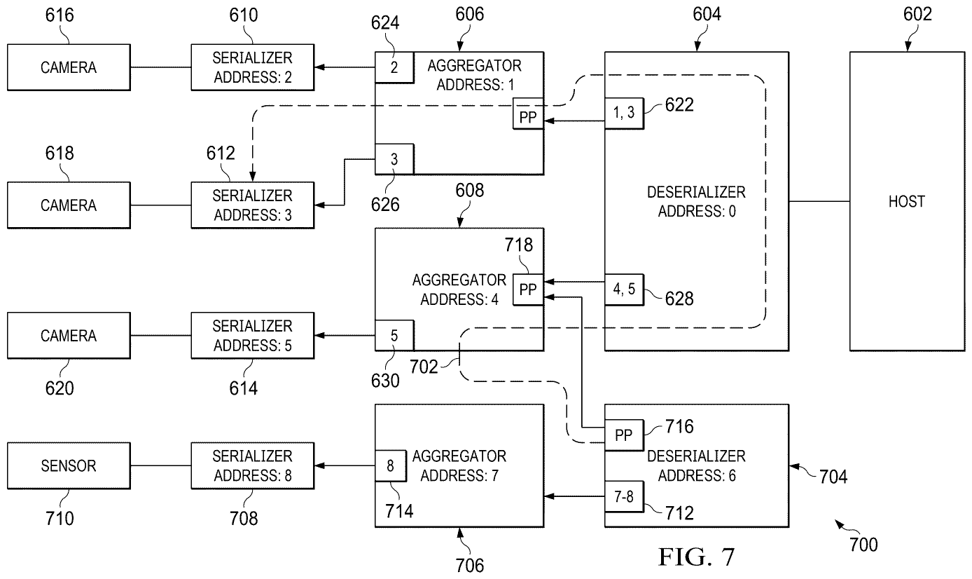

For example, turning to FIG. 7, an example second serial link network 700 is illustrated. The second serial link network 700 depicts an operation of the communication routing circuitry 510 of the addressing scheme circuitry 502 of FIG. 5. For example, the second serial link network 700 depicts an example message route 702, generated by the communication routing circuitry 510. In FIG. 7, the second serial link network 700 includes the devices of the first serial link network 600 of FIG. 6, including the host 602, the deserializer circuitry 604, the first aggregator 606, the second aggregator 608, the first serializer 610, the second serializer 612, the third serializer 614, the first camera 616, the second camera 618, and the third camera 620. The second serial link network 700 includes example second deserializer circuitry 704, an example third aggregator 706, an example fourth serializer 708, and an example sensor 710.

In FIG. 7, the node identifying circuitry 506 traverses the connection of devices from the second deserializer circuitry 704, and identifies the third aggregator 706, the fourth serializer 708, and the sensor 710. The address determination circuitry 508 assigns “Address: 6” to the second deserializer circuitry 704, responsive to the node identifying circuitry 506 determining that the second deserializer circuitry 704 is a root node. In some examples, serial link networks include two or more root nodes. However, the address determination circuitry 508 follows the pre-defined number sequence and does not use numbers that have been previously used (e.g., exhausted) as an address. So not every root node is given the first value of the pre-defined number sequence (e.g., 0, N, etc.).

The operations of the node identifying circuitry 506 and address determination circuitry 508 continue until the last device in the chain of devices has been identified and assigned an address and the address range is stored in memory of a sixth output port 712 second deserializer circuitry 704. For example, the address determination circuitry 508 assigns “Address: 7” to the third aggregator 706 and “Address: 8” to the fourth serializer 708. The address determination circuitry 508 stores address value “8” in a seventh output port 714 of the third aggregator 706, responsive to the node identifying circuitry 506 exhausting the devices connected to the seventh output port 714. When the node identifying circuitry 506 determines that the output ports of the third aggregator 706 have been exhausted, the address determination circuitry 508 stores an address range “7-8” in memory of the sixth output port 712 of the second deserializer circuitry 704.

Also, the node identifying circuitry 506 determines that the second deserializer circuitry 704 includes an eighth output port 716, which is connected to a parent port of the second aggregator 608. The eighth output port 716 becomes a parent port of the second deserializer circuitry 704 because the first deserializer circuitry 604 and second aggregator circuitry 608 can use the eighth output port 716 as an input. Therefore, the address determination circuitry 508 may update the address range of the fourth output port 628 to be “4-8”.

In FIG. 7, the communication routing circuitry 510 uses the parent port 716 to route a message targeted for an endpoint device not within the range of “7-8”. For example, the communication routing circuitry 510 is to communicate with the second camera 618 and, thus, send the message to the second serializer 612 having address value “3”. The communication routing circuitry 510 sends the message through an example parent port 718 of the second aggregator 608 in a reverse direction relative to the direction of a control flow. For example, the message is sent from the second aggregator 608 to the deserializer 604 (e.g., from the child node to the parent node), using the parent port and connecting serial link. In some examples, this operation is feasible due to the forward channel of the serial link. For example, the serial link connecting the first deserializer 604 and second aggregator 608 has a forward channel and back channel, as described above. The forward channel data flow is generally from endpoint device to host, whereas the back-channel data flow is from the host to endpoint device. Therefore, the communication routing circuitry 510 causes the message to be sent to the first deserializer circuitry 604 through the parent port 718. In some examples, the communication routing circuitry 510 includes an instruction in the message that causes the first deserializer circuitry 604 to identify the output port storing the address range including the address of the second serializer circuitry 612.

The communication routing circuitry 510 is therefore insensitive to direction of dataflow and, thus, supports communication originating from any device to any device in the second serial link network 700. The parent ports of intermediate devices (e.g., aggregators 606, 608, 706, etc.) enable direction insensitivity by not storing addresses or address ranges.

Returning to FIG. 5, the communication routing circuitry 510 may not route messages that are targeted to an inactive endpoint device. Endpoint devices may be inactive for a number of reasons. For example, a rear camera may be inactive when the vehicle is in “drive” mode, a sensor may be inactive due to physical damage to its power supply, a display may be inactive due to its configuration in the vehicle, etc. However, the programmable circuitry 504 may still provide the communication routing circuitry 510 with instructions to send a message to the inactive endpoint device. In such an example, the communication routing circuitry 510 may determine that an endpoint device is inactive based on feedback from serializer circuitry and do one of two things: ignore the programmable circuitry 504 instruction or execute a network diagnosis operation.

In some examples, the communication routing circuitry 510 executes a network diagnosis operation to check a health of the devices and determine which devices are not operable. The communication routing circuitry 510 may elect a network diagnosis over discarding/ignoring an instruction when the target endpoint device should be active, such as when power supply to the sensor should be provided, when the car is in “reverse” mode and the camera should be active), etc. In some examples, the communication routing circuitry 510 may elect a network diagnosis over discarding/ignoring an instruction when a pre-defined amount of time has passed since the last network diagnosis.

The communication routing circuitry 510 performs a network diagnosis by sending a message through all output ports of deserializer circuitry and requesting that each device in the serial link network send an acknowledgement including its assigned address. For example, the communication routing circuitry 510 sends a message through first output port 622, fourth output port 628, and sixth output port 712 to all the devices (e.g., aggregators 606, 608, 706, and serializers 610, 612, 614, and 708). When the device is active and does not have any type of power supply disruption, the device sends a response back to the programmable circuitry 504 or the communication routing circuitry 510. When the device is inactive or has a power supply disruption, the programmable circuitry 504 or the communication routing circuitry 510 does not receive a response from that device. The communication routing circuitry 510 then checks the received responses against a network topology table. The network topology table is a table storing information generated upon initial configuration of the addressing scheme. For example, the network topology table is generated by the programmable circuitry 504 at the startup of the serial link network, when the addressing scheme circuitry 502 assigns addresses to the devices in the serial link network. The network topology table is described in further detail below in connection with 14.

When the communication routing circuitry 510 compares the received responses to the network topology table, the communication routing circuitry 510 determines which devices are no longer connected active in the serial link network. If the communication routing circuitry 510 determines one or more devices are not connected, the communication routing circuitry 510 may trigger an addressing scheme program to reconfigure the addresses of the serial link network. In an addressing scheme reconfiguration, the communication routing circuitry 510 triggers the node identifying circuitry 506 to identify the nodes (e.g., devices) and sequence of nodes in the serial link network and triggers the address determination circuitry 508 to reassign a new sequence of address values to the nodes and update the address ranges stored in memory of output ports.

For example, in FIG. 7, the third camera 620 is inactive and, thus, the third serializer 614 is inactive. The communication routing circuitry 510 determines the third serializer 614 is inactive based on comparing feedback from all the nodes in the second serial link network 700 to the network topology. In some examples, the communication routing circuitry 510 may trigger the addressing scheme program to reconfigure the addresses in the second serial link network 700 based on skipping the third serializer 614 in the sequence, the reconfiguration to determine a new order of devices in the second serial link network 700.

The node identifying circuitry 506 identifies the first deserializer 604 as the first root node and determines the sequence of nodes from the first output port 622. The address determination circuitry 508 assigns “0” as the address of the first deserializer 604, “1” as the address of the first aggregator 606, “2” as the address of the first serializer 610, and “3” as the address of the second serializer 612. The address determination circuitry 508 stores address values of the first and second serializer circuitry 610, 612 in memory of the second and third output ports 624, 626, respectively, of the first aggregator 606 and stores “1-3” as the address range in the first output port 622 of the first deserializer 604.

A change occurs between the original network topology of the second serial link network 700 and the reconfigured network topology of the second serial link network 700 when the node identifying circuitry 506 scans the sequence of nodes connected to the fourth output port 628. For example, the node identifying circuitry 506 identifies the second aggregator 608 but does not identify the third serializer 614 or the third camera 620. In such an example, the address determination circuitry 508 assigns “4” as the address of the second aggregator 608 but does not assign the third serializer 614 an address. The address determination circuitry 508 stores address value “4” in the fourth output port 628 of the first deserializer 604, but does not store any address range because the only device accessible through the fourth output port 628 is the second aggregator 608.

The node identifying circuitry 506 moves on to the second root node in the second serial link network 700, based on identifying the second deserializer 704. The address determination circuitry 508 assigns “5” as the address of the second deserializer 704. The node identifying circuitry 506 determines the sequence of nodes accessible through the sixth output port 712. The address determination circuitry 508 assigns “6” as the address of the third aggregator 706 and “7” as the address of the fourth serializer 708. The address determination circuitry 508 stores the address value of the fourth serializer 708 in memory of the seventh output port 714 of the third aggregator 706 and stores “6-7” as the address range in the sixth output port 712 of the second deserializer 704. In some examples, the address determination circuitry 508 updates the address range of the fourth output port 628 to be “4-7” because the port 716 is a parent port connecting the first deserializer 604 to the second deserializer 704, giving the first deserializer 604 serial link access to the third aggregator 706 and fourth serializer 708.

In this example, the addressing scheme of the second serial link network 700 has been reconfigured. The communication routing circuitry 510 informs the programmable circuitry 504 of the inactive endpoint device for troubleshooting purposes. Until the problem is solved, the communication routing circuitry 510 routes messages to the active devices, without having to ignore incorrectly addressed messages.

In FIG. 5, the addressing scheme circuitry 502 includes the multicast table circuitry 512 to generate or populate multicast tables. A multicast table is a data structure used to map a single source device to multiple destination devices for transmission of data simultaneously to the multiple destination devices. For example, a multicast table is a table that maps a single aggregator to two or more serializers. Multicasting is the technique used by a host to transmit the same data to multiple destinations. Multicasting is beneficial, especially in audio and video data streaming, because it efficiently utilizes network bandwidth.

The programmable circuitry 504 implements multicasting by employing the multicast table circuitry 512 to distribute multicast tables across the serial link network at each device (e.g., deserializer circuitry, aggregator circuitry, and serializer circuitry). For example, every aggregator and deserializer stores a multicast table, rather than only the deserializer storing an alias-type table. In some examples, the tables are stored in data registers of the deserializers or aggregators. For example, the deserializer circuitry or the aggregator circuitry may include dedicated data registers that are to store multicast tables. The multicast table circuitry 512 configures the dedicated data registers. In some examples, the multicast table circuitry 512 configures the dedicated data registers to store destination addresses (e.g., addresses of the connected serializers). For example, a multicast table stored in a data register of the first aggregator 606 (FIG. 6 or FIG. 7) includes addresses “2” and “3”, because the first aggregator 606 is the source device of the first serializer 610 (Address: 2) and the second serializer 612 (Address: 3).

The multicast table circuitry 512 assigns an address to the multicast tables. The address assigned to the multicast table is part of the pre-defined number sequence used by the address determination circuitry 508. In some examples, the address determination circuitry 508 assigns an address to the multicast table when the multicast table circuitry 512 distributes the tables. In some examples, the node identifying circuitry 506 performs node identification and identifies a multicast table data register as a node for purposes of assigning the sequence of addresses. The communication routing circuitry 510 uses the address of the multicast table, rather than the addresses of the serializers, to perform multicasting of data. For example, the communication routing circuitry 510 sends a multicast message to the deserializer or aggregator that stores the target multicast table, and the deserializer or aggregator executes an instruction to replicate and send the multicast message to the two or more target devices.

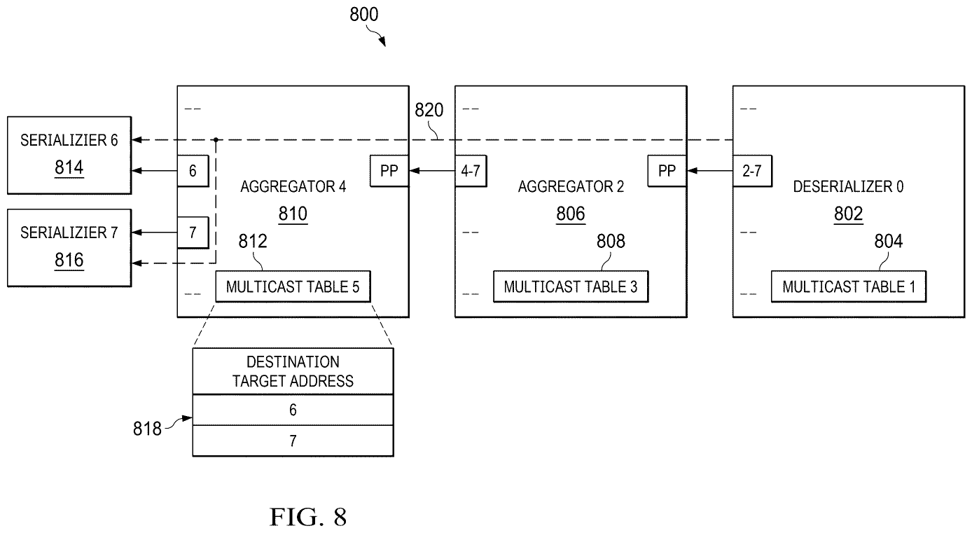

For example, turning to FIG. 8, an example third serial link network 800 is illustrated to execute a multicasting operation. The third serial link network 800 includes example deserializer zero 802, multicast table one 804, aggregator two 806, multicast table three 808, aggregator four 81810, multicast table five 81812, serializer six 81814, and serializer seven 81816. In FIG. 8, the zero, one, two, three, four, five, six, and seven numerical suffixes correspond to the addresses of the nodes. For example, the node identifying circuitry 506 identified deserializer 802, aggregators 806 and 810, serializers 814 and 816, and multicast tables 804, 808, and 812. The address determination circuitry 508 assigned the nodes addresses based on the sequence of the nodes. For example, deserializer 802 is assigned address “0”, multicast table 804 is assigned address “1”, aggregator 806 is assigned address “2”, multicast table 808 is assigned address “3”, aggregator 810 is assigned address “4”, multicast table 812 is assigned address “5”, serializer 814 is assigned address “6”, and serializer 816 is assigned address “7”. The address determination circuitry 508 stores address ranges in the output ports having access to two or more child nodes. For example, an output port of deserializer zero 802 stores address range “2-7”, indicating that the deserializer zero 802 can communicate with devices assigned address 2, 3, 4, 5, 6, and 7. The address determination circuitry 508 stores address range “4-7” in an output port of the aggregator two 806, indicating that aggregator two 806 can communicate with devices assigned addresses 4, 5, 6, and 7. Also, the address determination circuitry 508 stores address values (e.g., 6 and 7), rather than a range, in the output ports of aggregator four 810, indicating that one output port of aggregator four 810 is connected to serializer six 814, and the output port of aggregator four 810 is connected to serializer seven 816.

In FIG. 8, the third serial link network 800 includes multicast information 818 stored in the multicast table five 812. The multicast information 818 may be stored in a data register in the aggregator four 810. The multicast information 818 correlates with a number of output ports used in aggregator four 810. For example, aggregator four 810 appears to have four output ports, but only two are connected to serializers (e.g., serializers six and seven). However, the data register or multicast table five 812 is not limited to two entries. The multicast table five 812, and any other multicast table, may store any number of entries corresponding to a number of output ports of the associated device.

In FIG. 8, the multicasting operation begins when the communication routing circuitry 510 generates a multicast message 820 based on an instruction from the programmable circuitry 504 to send data to serializer six 814 and serializer seven 816 simultaneously. The communication routing circuitry 510 generates the multicast message 820 to be routed to the address of the multicast table five 812. For example, the communication routing circuitry 510 identifies an output port of the deserializer zero 802 having a routing range including address “5”. The communication routing circuitry 504 sends the multicast message 820 through the identified output port as a single message (e.g., single data packet, single stream, etc.). The multicast message 820 includes instructions for the aggregator four 810 to replicate the multicast message 820 and forward to target serializer six 814 and serializer seven 816. In some examples, the communication routing circuitry 510 includes instructions for the serializers six and seven 814, 816 to send acknowledgement responses back to the aggregator four 810. In such an example, aggregator four 810 can combine the acknowledgement responses into an acknowledgement packet and route the acknowledgement packet back to the deserializer circuitry zero 802 or programmable circuitry 504 to inform the programmable circuitry 504 that multicast was successful.

This mechanism of sending one message from the source results in a low network load relative to replicating the multicast message at the source and sending through the third serial link network 800. Also, the communication routing circuitry 510 improves troubleshooting of the third serial link network 800 by requiring the serializers to send acknowledgement responses. Previous multicasting mechanisms did not instruct endpoint devices to send acknowledgement responses and, thus, assumed the endpoint devices received the multicast message. Here, the communication routing circuitry 510 enables the programmable circuitry to identify serializers not receiving the multicast message 820 and take steps to resolve the non-receipt. Lastly, the multicast table circuitry 512 ensures that the number of destinations for multicasting is not limited or restricted. For example, because the multicast table circuitry 512 generates a multicast table for each aggregator and the number of entries in the multicast table is equal to the number of output ports in the aggregator, the number of destinations for multicasting is not limited. Therefore, the multicast table circuitry 512 and the communication routing circuitry 510 optimizes a network load of the third serial link network 800.

FIG. 9 is a flowchart representative of example machine-readable instructions or example operations 900 that may be at least one of executed, instantiated, or performed by programmable circuitry to implement the multicasting program to route multicast messages to two or more endpoint devices. The example machine-readable instructions or the example operations 900 of FIG. 9 begin at block 902, at which the addressing scheme circuitry 502 generates a multicast message to at least two endpoint devices, the multicast message is addressed to an address of a multicast table. For example, the communication routing circuitry 510 generates a multicast message to transmit data simultaneously to two or more serializers. The communication routing circuitry 510 generates the multicast message to be routed to the address of the multicast table storing addresses of the two or more serializers.

At block 904, the addressing scheme circuitry 502 identifies an output port of deserializer circuitry having a routing range including the address of the multicast table. For example, the communication routing circuitry 510 selects the output port of the deserializer circuitry that can access the multicast table.

At block 906, the addressing scheme circuitry 502 sends the multicast message through the output port having the routing range including the address of the multicast table. The communication routing circuitry 510 sends the multicast message through the identified output port as a single message (e.g., single data packet, single stream, etc.).

At block 908, the addressing scheme circuitry 502 causes the intermediate circuitry including the multicast table to replicate the multicast message. For example, the multicast table circuitry 512 generates a multicast table that is stored in a data register of an intermediate device, such as aggregator circuitry and deserializer circuitry. The communication routing circuitry 510 includes instructions in the multicast message for the intermediate device to replicate the multicast message. In some examples, replicating the message refers to creating multiple copies of the message.

At block 910, the addressing scheme circuitry 502 causes the intermediate circuitry to route the multicast message to the at least two endpoint devices. For example, the communication routing circuitry 510 includes instructions in the message that cause the intermediate device (e.g., an aggregator, deserializer, etc.) to forward the message to the respective serializers after the message has been replicated.

At block 912, the addressing scheme circuitry 502 determines whether an acknowledgement from the at least two endpoint devices have been received. For example, the communication routing circuitry 510 includes instructions for the serializers connected to the endpoint devices to send acknowledgement responses back to the originating intermediate device.

When the addressing scheme circuitry 502 determines that an acknowledgement has not been received (e.g., block 912 returns a value NO), the programmable circuitry 504 troubleshoots (block 914). For example, the programmable circuitry 504 identifies serializers not receiving the multicast message and takes steps to resolve the non-receipt.

When the addressing scheme circuitry 502 determines that an acknowledgement has been received (e.g., block 912 returns a value YES), the addressing scheme circuitry 502 causes the intermediate device to combine the acknowledgements. For example, the communication routing circuitry 510 instructs the intermediate device to combine the individual acknowledgements into a consolidated view of the overall transmission status.

At block 918, the addressing scheme circuitry 502 causes the intermediate device to route the acknowledgements back to the source. For example, the communication routing circuitry 510 instructs the aggregator circuitry or deserializer circuitry to send the consolidated acknowledgements back to the programmable circuitry 504 to determine the success of the multicasting transmission.

The multicasting operations 900 end when the programmable circuitry 504 receives the consolidated acknowledgements. In some examples, the multicasting operations 900 are repeated when a multicast message is generated.

Returning to FIG. 5, the addressing scheme circuitry 502 includes the interface circuitry 514 to receive information from devices in the serial link network and provide instructions to devices in the serial link network. For example, the interface circuitry 514 provides address values to output ports of the aggregator circuitry and deserializer circuitry in the serial link network, receives the acknowledgement responses from serializer circuitry and forwards to the communication routing circuitry 510 or to the programmable circuitry 504, provides multicast tables to the aggregator circuitry and deserializer circuitry in the serial link network, and provides routing ranges (e.g., address ranges) to aggregator circuitry and deserializer circuitry. In some examples, the interface circuitry 514 is implemented by hardware, such as a dedicated connector or bus. Also, the interface circuitry 514 is implemented by software, such as application programming interface(s) (APIs) and protocols.

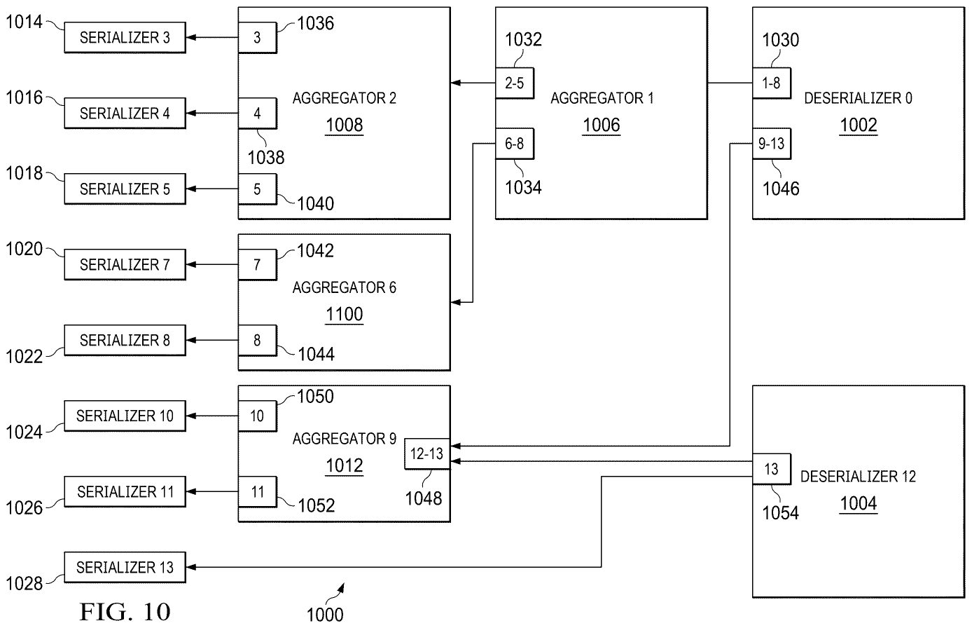

FIG. 10 is an example fourth serial link network 190 to illustrate an implementation of the addressing scheme program of the addressing scheme circuitry 502. The fourth serial link network 1000 of FIG. 10 includes an example first deserializer 1002 and an example second deserializer 1004, an example first aggregator 1006, an example second aggregator 1008, an example third aggregator 1010, an example fourth aggregator 1012, and example serializers 1014, 1016, 1018, 1020, 1022, 1024, 1026, 1028. The example serializers 1014, 1016, 1018, 1020, 1022, 1024, 1026, 1028 may be connected to any type of endpoint device, such as a camera, a sensor, a display, etc.

In FIG. 10, the fourth serial link network 1000 has a different configuration than the first serial link network 600, the second serial link network 700, and then the third serial link network 800. For example, in FIG. 10, the first deserializer 1002 has a first output port 1030 coupled to a parent port of the first aggregator 1006. A second output port 1032 of the first aggregator 1006 is coupled to a parent port of the second aggregator 1008 and a third output port 1034 of the first aggregator 1006 is coupled to a parent port of the third aggregator 1010. This configuration is different from configurations of the first serial link network 600, the second serial link network 700, and the third serial link network 800 because two output ports of the first aggregator 1006 are connected, respectfully, to other aggregators rather than being connected to serializers.

In the fourth serial link network 1000, a fourth output port 1036 of the second aggregator 1008 is coupled to the first serializer 1014, a fifth output port 1038 of the second aggregator 1008 is coupled to the second serializer 1016, and a sixth output port 1040 of the second aggregator 1008 is coupled to the third serializer 1018. In the fourth serial link network 1000, a seventh output port 1042 of the third aggregator 1010 is coupled to the fourth serializer 1020 and an eighth output port 1044 of the third aggregator 1010 is coupled to the fifth serializer 1022. In the fourth serial link network 1000, a ninth output port 1046 of the first deserializer 1002 is coupled to a first parent port of the fourth aggregator 1012 and port of the second deserializer 1004 is coupled to a port 1048 of the fourth aggregator 1012. As described in further detail below, the port of the second deserializer 1004 coupled to port 1048 is a parent port because any port that does not store an address range is considered to be a parent port. A tenth output port 1050 of the fourth aggregator 1012 is coupled to the sixth serializer 1024 and an eleventh output port 1052 of the fourth aggregator 1012 is coupled to the seventh serializer 1026. In the fourth serial link network 1000, a thirteenth output port 1054 of the second deserializer 1004 is coupled to the eighth serializer 1028.

In order to assign addresses to each of the nodes (e.g., deserializers, serializers, and aggregators) in the fourth serial link network 1000, the addressing scheme circuitry 502 has to select a primary root node. For example, because there are two deserializers 1002, 1004, there are two root nodes (e.g., two devices where communications originate from). Here, the node identifying circuitry 506 identifies primary root node of the fourth serial link network 1000 to be the first deserializer 1002. The address determination circuitry 508 initializes the address number sequence to start at the beginning of the number sequence and, thus, assigns the first deserializer 1002 with the address value “0”. The node identifying circuitry 506 identifies an output port of the primary root node to analyze. For example, the node identifying circuitry 506 identifies and selects the first output port 1030 to analyze its connection (direct or indirect) to one or more endpoint devices. The node identifying circuitry 506 determines whether any child node is connected to the first output port 1030. The node identifying circuitry 506 determines that the first aggregator 1006 is connected to the first output port 1030, and the address determination circuitry 508 assigns the next number in the number sequence as the address value of the first aggregator 1006. For example, the address determination circuitry 508 assigns the first aggregator 1006 with the address value “1”.

Before moving on to the next output port of the root node, the node identifying circuitry 506 determines whether the child node has any output ports. For example, the node identifying circuitry 506 identifies the second output port 1032 and the third output port 1034 of the first aggregator 1006. The node identifying circuitry 506 selects one of the output ports to analyze, starting with the second output port 1032. The node identifying circuitry 506 determines whether any child node is connected to the second output port 1032. The node identifying circuitry 506 determines that the second aggregator 1008 is connected to the second output port 1032, and the address determination circuitry 508 assigns the next number in the number sequence as the address value of the second aggregator 1008. For example, the address determination circuitry 508 assigns the second aggregator 1008 with the address value “2”.

Before moving on to the next output port of the parent node (e.g., the first aggregator 1006), the node identifying circuitry 506 determines whether the child node (e.g., the second aggregator 1008) has any output ports. For example, the node identifying circuitry 506 identifies the fourth output port 1036, the fifth output port 1038, and the sixth output port 1040 of the second aggregator 1008. The node identifying circuitry 506 selects one of the output ports to analyze, starting with the fourth output port 1036. The node identifying circuitry 506 determines whether any child node is connected to the fourth output port 1036. The node identifying circuitry 506 determines that the first serializer 1014 is connected to the fourth output port 1036, and the address determination circuitry 508 assigns the next number in the number sequence as the address value of the first serializer 1014. For example, the address determination circuitry 508 assigns the first serializer 1014 with the address value “3”.

In some examples, the node identifying circuitry 506 determines whether child node (e.g., the first serializer 1014) has any output ports. The node identifying circuitry 506 determines that the child node is the first serializer 1014 and does not have any output ports other than ones connected to endpoint devices, which are not included in the addressing scheme. Therefore, because the node identifying circuitry 506 determines that the child node (e.g., the first serializer 1014) does not have any output ports, the address determination circuitry 508 stores the child node address in memory at selected parent node output port. For example, the address determination circuitry 508 stores address value “3” in memory of the fourth output port 1036.

The node identifying circuitry 506 continues analyzing the connections of the output ports of the current parent node until all the output ports of the current parent node are exhausted (e.g., analyzed and assigned an address). Therefore, the node identifying circuitry 506 selects the next output port, fifth output port 1038, of the second aggregator 1008 to analyze. The node identifying circuitry 506 determines whether any child node is connected to the fifth output port 1038. The node identifying circuitry 506 determines that the second serializer 1016 is connected to the fifth output port 1038, and the address determination circuitry 508 assigns the next number in the number sequence as the address value of the second serializer 1016. For example, the address determination circuitry 508 assigns the second serializer 1016 with the address value “4”.

In some examples, the node identifying circuitry 506 determines whether the child node (e.g., the second serializer 1016) has any output ports. The node identifying circuitry 506 determines that the child node is a serializer and does not have any output ports other than ones connected to endpoint devices. The address determination circuitry 508 stores the child node address in memory at selected parent node output port. For example, the address determination circuitry 508 stores address value “4” in memory of the fifth output port 1038.

The node identifying circuitry 506 selects the next output port, sixth output port 1040, of the second aggregator 1008 to analyze. The node identifying circuitry 506 determines whether any child node is connected to the sixth output port 1040. The node identifying circuitry 506 determines that the third serializer 1018 is connected to the sixth output port 1040, and the address determination circuitry 508 assigns the next number in the number sequence as the address value of the third serializer 1018. For example, the address determination circuitry 508 assigns the third serializer 1018 with the address value “5”.

The node identifying circuitry 506 determines whether a child node (e.g., the third serializer 1018) has any output ports. The node identifying circuitry 506 determines that the child node is a serializer and does not have any output ports other than ones connected to endpoint devices. The address determination circuitry 508 stores the child node address in memory at selected parent node output port. For example, the address determination circuitry 508 stores address value “5” in memory of the sixth output port 1040.

In some examples, when the node identifying circuitry 506 determines that no other output ports of the selected parent node are to be analyzed, the address determination circuitry 508 stores an address range in memory of the previous parent node output port. For example, the address determination circuitry 508 stores address range “2-5” in memory of the second output port 1032 of the first aggregator, indicating that the first aggregator 1006 can access devices 2, 3, 4, and 5 (e.g., second aggregator 1008, first serializer 1014, second serializer 1016, and third serializer 1018) from the second output port 1032. Also, when the node identifying circuitry 506 determines that no other output ports of the selected parent node are to be analyzed, the node identifying circuitry 506 reverts back to the previous parent node to determine whether the previous parent node has any additional output ports to analyze. For example, the node identifying circuitry 506 returns to the first aggregator 1006 to determine whether additional output ports are to be traversed.

The node identifying circuitry 506 selects the next output port to analyze, third output port 1034. The node identifying circuitry 506 determines whether any child node is connected to the third output port 1034. The node identifying circuitry 506 determines that the third aggregator 1010 is connected to the third output port 1034, and the address determination circuitry 508 assigns the next number in the number sequence as the address value of the third aggregator 1010. For example, the address determination circuitry 508 assigns the third aggregator 1010 with the address value “6”.

Before determining whether there is an additional output port of the parent node (e.g., the first aggregator 1006), the node identifying circuitry 506 determines whether the child node (e.g., the third aggregator 1010) has any output ports. For example, the node identifying circuitry 506 identifies the seventh output port 1042 and eighth output port 1044 of the second aggregator 1008. The node identifying circuitry 506 selects one of the output ports to analyze, starting with the seventh output port 1042. The node identifying circuitry 506 determines whether any child node is connected to the seventh output port 1042. The node identifying circuitry 506 determines that the fourth serializer 1020 is connected to the seventh output port 1042, and the address determination circuitry 508 assigns the next number in the number sequence as the address value of the fourth serializer 1020. For example, the address determination circuitry 508 assigns the fourth serializer 1020 with the address value “7”.

In some examples, the node identifying circuitry 506 determines whether child node (e.g., the fourth serializer 1020) has any output ports. The node identifying circuitry 506 determines that the child node is a serializer and does not have any output ports other than ones connected to endpoint devices. The address determination circuitry 508 stores the child node address in memory at selected parent node output port. For example, the address determination circuitry 508 stores address value “7” in memory of the seventh output port 1042.

The node identifying circuitry 506 continues analyzing the connections of the output ports of the third aggregator 1010 until all the output ports of the third aggregator 1010 (e.g., the current parent node) are exhausted (e.g., analyzed and assigned an address). Therefore, the node identifying circuitry 506 selects the next output port, eighth output port 1044 to analyze. The node identifying circuitry 506 determines whether any child node is connected to the eighth output port 1044. The node identifying circuitry 506 determines that the fifth serializer 1022 is connected to the eighth output port 1044, and the address determination circuitry 508 assigns the next number in the number sequence as the address value of the fifth serializer 1022. For example, the address determination circuitry 508 assigns the fifth serializer 1022 with the address value “8”.

Because the node identifying circuitry 506 identified a serializer, the node identifying circuitry 506 determines that the fifth serializer 1022 has no other output ports to analyze, and the address determination circuitry 508 stores address value “8” in memory of the eighth output port 1044. In some examples, when the node identifying circuitry 506 determines that no other output ports of the selected parent node (e.g., third aggregator 1010) are to be analyzed, the address determination circuitry 508 stores an address range in memory of the previous parent node output port. For example, the address determination circuitry 508 stores address range “6-8” in memory of the third output port 1034 of the first aggregator, indicating that the first aggregator 1006 can access devices 6, 7, and 8 (e.g., third aggregator 1010, fourth serializer 1020, and fifth serializer 1022) from the third output port 1034. Also, when the node identifying circuitry 506 determines that no other output ports of the selected parent node (e.g., third aggregator 1010) are to be analyzed, the node identifying circuitry 506 reverts back to the previous parent node to determine whether the previous parent node has any additional output ports to analyze. For example, the node identifying circuitry 506 returns to the first aggregator 1006 to determine whether additional output ports are to be traversed.

When no additional ports of the previous parent node (e.g., first aggregator 1006) are to be analyzed, the previous parent node becomes the current parent node and address determination circuitry 508 stores an address range in memory of the previous parent node output port. For example, the address determination circuitry 508 stores address range “1-8” in memory of the first output port 1030 of the first deserializer 1002, indicating that the first deserializer 1002 can access devices 1, 2, 3, 4, 5, 6, 7, and 8 (e.g., first aggregator 1006, second aggregator 1008, first serializer 1014, second serializer 1016, third serializer 1018, third aggregator 1010, fourth serializer 1020, and fifth serializer 1022) from the first output port 1030. As can be seen, the address determination circuitry 508 stores an address range, in memory of an output port of any parent having two or more child nodes connected to the output port, after all the connecting child nodes have been assigned an address.

Also, once the previous parent node becomes the current parent node, the node identifying circuitry 506 reverts back to the previous parent node (e.g., the primary root node/first deserializer 1002) from the current parent node to determine whether the previous parent node has any additional output ports to analyze. For example, the node identifying circuitry 506 determines whether the first deserializer 1002 has an additional output port to analyze. The node identifying circuitry 506 identifies and selects the ninth output port 1046 to analyze its connection (direct or indirect) to one or more endpoint devices. The node identifying circuitry 506 determines whether any child node is connected to the ninth output port 1046. The node identifying circuitry 506 determines that the fourth aggregator 1012 is connected to the ninth output port 1046, and the address determination circuitry 508 assigns the next number in the number sequence as the address value of the fourth aggregator 1012. For example, the address determination circuitry 508 assigns the fourth aggregator 1012 with the address value “9”.

Before checking whether the root node has a new output port, the node identifying circuitry 506 determines whether the child node (e.g., the fourth aggregator 1012) has any output ports. For example, the node identifying circuitry 506 identifies the tenth output port 1050 and the eleventh output port 1052 of the fourth aggregator 1012. The node identifying circuitry 506 selects one of the output ports to analyze, starting with the tenth output port 1050. The node identifying circuitry 506 determines whether any child node is connected to the tenth output port 1050. The node identifying circuitry 506 determines that the sixth serializer 1024 is connected to the tenth output port 1050, and the address determination circuitry 508 assigns the next number in the number sequence as the address value of the sixth serializer 1024. For example, the address determination circuitry 508 assigns the sixth serializer 1024 with the address value “10”.

In some examples, the node identifying circuitry 506 determines whether child node (e.g., the sixth serializer 1024) has any output ports. The node identifying circuitry 506 determines that the child node is a serializer and does not have any output ports other than ones connected to endpoint devices. The address determination circuitry 508 stores the child node address in memory at selected parent node output port. For example, the address determination circuitry 508 stores address value “10” in memory of the tenth output port 1050.

The node identifying circuitry 506 continues analyzing the connections of the output ports of the current parent node until all the output ports of the current parent node are exhausted (e.g., analyzed and assigned an address). Therefore, the node identifying circuitry 506 selects the next output port, eleventh output port 1052, of the fourth aggregator 1012 to analyze. The node identifying circuitry 506 determines whether any child node is connected to the eleventh output port 1052. The node identifying circuitry 506 determines that the seventh serializer 1026 is connected to the eleventh output port 1052, and the address determination circuitry 508 assigns the next number in the number sequence as the address value of the seventh serializer 1026. For example, the address determination circuitry 508 assigns the seventh serializer 1026 with the address value “11”.

In some examples, the node identifying circuitry 506 determines that the child node (e.g., the seventh serializer 1026) is a serializer and does not have any output ports other than ones connected to endpoint devices. The address determination circuitry 508 stores the child node address in memory at selected parent node output port. For example, the address determination circuitry 508 stores address value “11” in memory of the eleventh output port 1052 of the fourth aggregator 1012.

In some examples, when the node identifying circuitry 506 determines that no other output ports of the selected parent node are to be analyzed, the address determination circuitry 508 would normally store an address range in memory of the previous parent node output port. For example, the address determination circuitry 508 would store address range “9-11” in memory of the ninth output port 1046 of the first deserializer 1002, indicating that the first deserializer 1002 can access devices 9, 10, and 11 (e.g., fourth aggregator 1012, sixth serializer 1024 and seventh serializer 1026) from the ninth output port 1046. However, the node identifying circuitry 506 determines that the current parent node (e.g., the fourth aggregator 1012) has another port, twelfth port 1048, that needs to be analyzed. The node identifying circuitry 506 determines that the additional port 1048 of the fourth aggregator 1012 is connected to the second deserializer 1004. In some examples, the additional port 1048 of the fourth aggregator 1012 may be input port or an output port, because the twelfth port may output data to the second deserializer 1004 or may receive input data from the second deserializer 1004.

The node identifying circuitry 506 follows the connection from the twelfth port 1048 to identify connecting devices and assign addresses to those devices. For example, the node identifying circuitry 506 determines that the second deserializer 1004 is connected to the twelfth port 1048, and the address determination circuitry 508 assigns the next number in the number sequence as the address value of the second deserializer 1004. For example, the address determination circuitry 508 assigns the second deserializer 1004 with the address value “12”.

The node identifying circuitry 506 determines whether the child node (e.g., the second deserializer 1004) has any output ports. For example, the node identifying circuitry 506 identifies the thirteenth output port 1054 of the second deserializer 1004. The node identifying circuitry 506 determines whether any child node is connected to the thirteenth output port 1054. The node identifying circuitry 506 determines that the eighth serializer 1028 is connected to the thirteenth output port 1054, and the address determination circuitry 508 assigns the next number in the number sequence as the address value of the eighth serializer 1028. For example, the address determination circuitry 508 assigns the eighth serializer 1028 with the address value “13”.

The node identifying circuitry 506 determines whether child node (e.g., the eighth serializer 1028) has any output ports. The node identifying circuitry 506 determines that the child node is a serializer and does not have any output ports other than ones connected to endpoint devices. The address determination circuitry 508 stores the child node address in memory at selected parent node output port. For example, the address determination circuitry 508 stores address value “13” in memory of the thirteenth output port 1054 of the second deserializer.

In some examples, when the node identifying circuitry 506 determines that no other ports of the selected parent node are to be analyzed, the address determination circuitry 508 stores an address range in memory of the previous parent node (e.g., fourth aggregator 1012) port. For example, the address determination circuitry 508 stores address range “12-13” in memory of the twelfth output port 1048 of the fourth aggregator 1012, indicating that the fourth aggregator 1012 can access devices 12 and 13 (e.g., second deserializer 1004 and eighth serializer 1028) from the twelfth port 1048. Also, when the node identifying circuitry 506 determines that no other output ports of the selected parent node (e.g., second deserializer 1004) are to be analyzed, the node identifying circuitry 506 reverts back to the previous parent node (e.g., fourth aggregator 1012) to determine whether the previous parent node has any additional output ports to analyze. For example, the node identifying circuitry 506 returns to the fourth aggregator 1012 to determine whether additional output ports are to be traversed. In some examples, the port of the second deserializer 1004 that is connected to the twelfth port 1048 of the fourth aggregator 1012 becomes a parent port (e.g., a default port). The address determination circuitry 508 does not store any address value or address range in that port of the second deserializer 1004. In some examples, the parent port can be used by the first deserializer 1002 to communicate with the endpoint device connected to the eighth serializer 1028. In some examples, the parent port can be used by the second deserializer 1004 to communicate with any one of the first serializer 1014, the second serializer 1016, the third serializer 1018, the fourth serializer 1020, the fifth serializer 1022, the sixth serializer 1024, or seventh serializer 1026.

When no additional ports of the previous parent node (e.g., fourth aggregator 1012) are to be analyzed, the previous parent node becomes the current parent node and address determination circuitry 508 stores an address range in memory of the previous parent node output port. For example, the address determination circuitry 508 stores address range “9-13” in memory of the ninth output port 1046 of the first deserializer 1002, indicating that the first deserializer 1002 can access devices 9, 10, 11, 12, and 13 (e.g., fourth aggregator 1012, sixth serializer 1024, seventh serializer 1026, second deserializer 1004, and eighth serializer 1028) from the ninth output port 1046 of the first deserializer 1002.

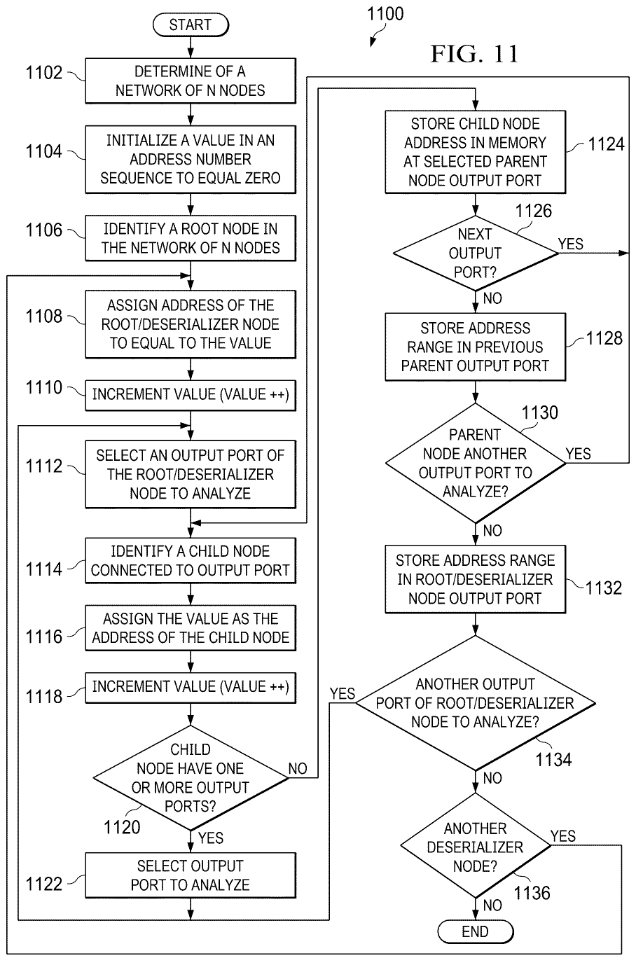

FIG. 11 is a flowchart representative of example machine-readable instructions or example operations 1100 that may be at least one of executed, instantiated, or performed by programmable circuitry to implement the addressing scheme program to assign addresses to devices in a serial link network. The example machine-readable instructions or the example operations 1100 of FIG. 11 begin at block 1102, at which the addressing scheme circuitry 502 (FIG. 5) determines a network of n nodes. For example, the node identifying circuitry 506 (FIG. 5) generates an acyclic graph of a serial link network (e.g., serial link network 600, 700, 800, 1000, etc.) including nodes and edges, where the nodes and edges are an abstraction of devices and respective connections.

At block 1104, the addressing scheme circuitry 502 initializes a value in an address number sequence to equal zero. For example, the address determination circuitry 508 (FIG. 5) initializes a variable “value” to equal a first number in the pre-defined number sequence (e.g., value=0).

At block 1106, the addressing scheme circuitry 502 identifies a root node in the network of n nodes. For example, the node identifying circuitry 506 identifies deserializer circuitry 1002 in the fourth serial link network 1000 (FIG. 10) and determines that the deserializer circuitry 1002 is the root node.

At block 1108, the addressing scheme circuitry 502 assigns the address of the root node to equal the value. For example, the address determination circuitry 508 assigns “0” as the address of deserializer circuitry 1002.

At block 1210, the addressing scheme circuitry 502 increments the value. For example, the address determination circuitry 508 increments the value to the next number in the pre-defined number sequence (e.g., value++; value=1). The address determination circuitry 508 increments the value in preparation for the next identified node.

At block 1212, the addressing scheme circuitry 502 selects an output port of the root node to analyze. For example, the node identifying circuitry 506 selects a serial link output port of the deserializer circuitry to follow. In following the fourth serial link network 1000, the node identifying circuitry 506 selects the first output port 1030 (FIG. 10) of the deserializer circuitry 1002 to follow the connections of.

At block 1214, the addressing scheme circuitry 502 identifies a child node connected to the output port. For example, the node identifying circuitry 506 determines whether any device, such as aggregator circuitry or serializer circuitry, is connected to the deserializer circuitry at the selected output port of the root node. In following the nodes of the fourth serial link network 1000, the node identifying circuitry 506 determines that the first aggregator circuitry 1006 (FIG. 10) is connected to the deserializer circuitry 1002 at the first output port 1030.

At block 1216, the addressing scheme circuitry 502 assigns the value as the address of the child node. For example, the address determination circuitry 508 assigns the next number in the number sequence as the address of the child node, such as aggregator circuitry or serializer circuitry, connected to the selected output port. In following the nodes of the fourth serial link network 1000, the address determination circuitry 508 assigns the value “1” to first aggregator circuitry 1006.

At block 1218, the addressing scheme circuitry 502 increments the value. For example, the address determination circuitry 508 increments the value to the next number in the pre-defined number sequence (e.g., value++; value=n). The address determination circuitry 508 increments the value in preparation for the next identified node. In following the connections configured in the fourth serial link network 1000, the address determination circuitry 508 increments the value by one to get the next value “2”.

At block 1120, the addressing scheme circuitry 502 determines whether the child node has one or more output ports. For example, the node identifying circuitry 506 determines whether the selected aggregator circuitry or serializer circuitry has serial link output ports based on whether the abstracted node has any edges. In some examples, the node identifying circuitry 506 determines whether the first aggregator 1006 has any output ports to analyze. When the node identifying circuitry 506 determines that the child node has one or more output ports (e.g., block 1120 returns a value YES), control goes to block 1122. When the node identifying circuitry 506 determines that the child node does not have one or more output ports (e.g., block 1120 returns a value NO), control goes to block 1124.

At block 1122, the addressing scheme circuitry 502 selects an output port to analyze. For example, the node identifying circuitry 506 selects one of the one or more serial link output ports of the current child node to follow. In some examples, the child node becomes a parent node when the child node has one or more output ports, because the child node is a predecessor to one or more nodes, making it a parent node to those one or more nodes. In following the connections configured in the fourth serial link network 1000, the node identifying circuitry 506 selects the second output port 1032 or the third output port 1034 to follow. When the node identifying circuitry 506 selects an output port, control returns to block 1214, where the node identifying circuitry 506 identifies a child node connected to the selected output port. The process of identifying a child node (block 1214), assigning an address value (block 1216), incrementing the address value (block 1218), and determining whether the identified child node has one or more outputs (block 1120) is repeated until the node identifying circuitry 506 reaches the bottom of the acyclic graph (e.g., the endpoint device) for that particular output port connection, where the last node does not have one or more output ports to analyze. For example, in following the connection configuration in the fourth serial link network 1000, the node identifying circuitry 506 follows the second output port 1032 connection until the node identifying circuitry 506 reaches the first serializer 1014 and the address determination circuitry 508 assigns the address value “3” to the first serializer 1014.

At block 1124, the addressing scheme circuitry 502 stores the child node address in memory at the selected parent node output port. For example, the address determination circuitry 508 stores the address of the recently addressed serializer circuitry in memory of its parent node output port (e.g., output port of aggregator circuitry or output port of deserializer circuitry). For example, in the connection configuration of the fourth serial link network 1000, the address determination circuitry 508 stores address value “3”, corresponding to the first serializer 1014, in memory of the fourth output port 1036 of the second aggregator 1008.

At block 1126, the addressing scheme circuitry 502 determines whether there is another output port to analyze. For example, when the child node does not have any output ports, the node identifying circuitry 506 returns to the parent node and looks for additional, un-addressed serial link output ports. For example, in the connection configuration of the fourth serial link network 1000, the node identifying circuitry 506 returns to the second aggregator 1008 to determine whether the other two serial link output ports have been analyzed.

When the node identifying circuitry 506 determines that there is another output port (e.g., block 1126 returns a value YES), control returns to block 1214, where the node identifying circuitry 506 identifies a child node connected to the selected output port. For example, in the connection configuration of the fourth serial link network 1000, the node identifying circuitry 506 determines that the second serializer 1016 is connected to the fifth output port 1038 of the second aggregator 1008. The process of assigning the value to the child node (block 1216), incrementing the value (block 1218), looking for additional output ports of the child node (block 1120), and storing the address of the child node in memory of the parent node output port (block 1124) is repeated until the parent node does not have any more output ports to analyze (block 1126).

When the node identifying circuitry 506 determines that there is not another output port (e.g., block 1126 returns a value NO), control goes to block 1128. At block 1128, the addressing scheme circuitry 502 stores an address range in the previous parent output port. For example, the address determination circuitry 508 stores a range in memory of the output port of prior parent port, where the prior parent node is predecessor node to the node identified at block 1214. An address range includes two address values, the first value indicative of the address of the immediate child node to the previous parent output port and the second value indicative of the address of the last child node in the sequence of nodes from the previous parent output port. In some examples, the prior parent node is aggregator circuitry or deserializer circuitry. For example, an address range is not stored in memory of serializer circuitry because serializer circuitry is connected to an endpoint device. In the connection configuration of the fourth serial link network 1000, the address determination circuitry 508 stores an address range “2-5” in the second output port 1032 of the first aggregator circuitry 1006.

At block 1130, the addressing scheme circuitry 502 determines whether the parent node has another output port to analyze. For example, the node identifying circuitry 506 determines whether the serial link output ports of the previous parent node have been exhausted. For example, the node identifying circuitry 506 determines whether the first aggregator 1004 has another output port to analyze.

When the node identifying circuitry 506 determines there is another port to analyze (e.g., block 1130 returns a value YES), control returns to block 1214. For example, the node identifying circuitry 506 determines that the third output port 1034 has not been analyzed, and the node identifying circuitry 506 follows the connection from the third output port 1034 to the third aggregator 1010, then onto the fourth and fifth serializers 1020 and 1022, until the address determination circuitry 508 stores an address range in the third output port 1034.

When the node identifying circuitry 506 determines that there is not another output port to analyze (e.g., block 1130 returns a value NO), the addressing scheme circuitry 502 stores an address range in the root node output port (block 1132). For example, the address determination circuitry 508 stores an address range corresponding to the address of the first identified child node of the output port selected at block 1212 and the address of the last identified child node (determined at block 1214) of the output port selected at block 1212. For example, the address determination circuitry 508 stores address range “1-8” in memory of the first output port 1030 of first deserializer 1002.

At block 1134, the addressing scheme circuitry 502 determines whether there is another output port of the root/deserializer node to analyze. For example, the node identifying circuitry 506 determines whether the deserializer circuitry has any serial link output ports that have not been addressed. When the addressing scheme circuitry 502 determines there is another output port of the root node to analyze (e.g., block 1134 returns a value YES), control returns to block 1212 where the addressing scheme circuitry 502 selects the next output port. For example, the node identifying circuitry 506 exhausts the serial link output ports of the root node in order to identify all possible devices in the serial link network.

When the addressing scheme circuitry 502 determines there is not another output port of the root node to analyze (e.g., block 1134 returns a value NO), the addressing scheme circuitry determines whether there is another deserializer node (block 1136). For example, the node identifying circuitry 506 determines whether there is another deserializer circuitry in the serial link network, based on whether a separate tree or hierarchy in the acyclic graph exists in the serial link network. In some examples, a serial link network has two or more deserializers, whether connected directly or indirectly through parent ports of child nodes or disconnected, where one of the deserializers is selected as the root node for the addressing scheme.

When the addressing scheme circuitry 502 determines that another root node exists in the serial link network (e.g., block 1136 returns a value YES), control returns to block 1108, because the addressing scheme circuitry 502 continues following the pre-defined number sequence. For example, even where a deserializer is disconnected from a previously addressed deserializer, the addressing scheme circuitry 502 does not give the newly identified deserializer circuitry an address value previously assigned to any other nodes in the serial link circuitry.

When the addressing scheme circuitry 502 determines that there is not another root node to address in the serial link network (e.g., block 1136 returns a value NO), the operations 1100 end. For example, the addressing scheme program is complete when all nodes in the serial link network have been assigned an address. In some examples, the operations 1100 may be repeated when the programmable circuitry 504 triggers a re-addressing program. For example, when a device has been added to or removed from the serial link network, the programmable circuitry 504 may trigger a re-addressing scheme to update the addresses of the devices.

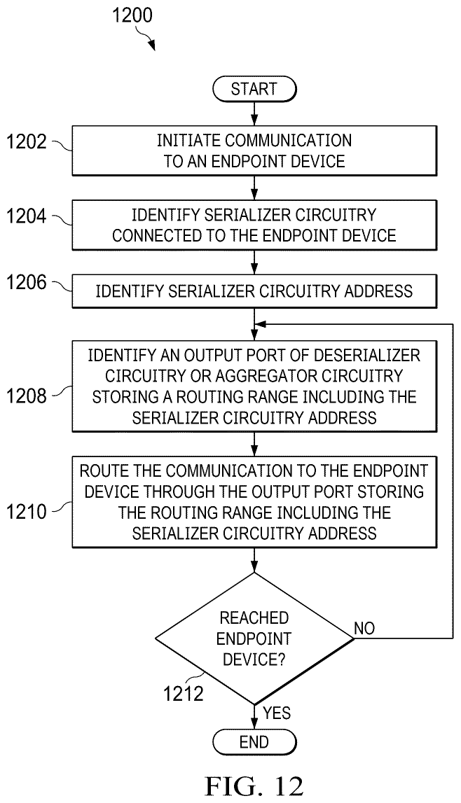

FIG. 12 is a flowchart representative of example machine-readable instructions or example operations 1200 that may be at least one of executed, instantiated, or performed by programmable circuitry to implement the communication routing program to route messages to an endpoint device. The example machine-readable instructions or the example operations 1200 of FIG. 12 begin at block 1202, at which the addressing scheme circuitry 502 (FIG. 5) initiates communication to an endpoint device. For example, the communication routing circuitry 510 (FIG. 5) may be triggered to send an instruction or update to a camera, reconfigure settings for a sensor, etc.

At block 1204, the addressing scheme circuitry 502 identifies serializer circuitry connected to the endpoint device. For example, the communication routing circuitry 510 uses information stored in memory of the programmable circuitry 504, such as a network diagnosis analysis table, etc., to identify specific serializer circuitry connected coupled to and sending data directly to the endpoint device. The communication routing circuitry 510 may identify second serializer circuitry 1016 (FIG. 10) coupled to the target endpoint device.

At block 1206, the addressing scheme circuitry 502 identifies the address of the serializer circuitry. For example, the communication routing circuitry 510 determines the address value assigned to the serializer circuitry by the address determination circuitry 508 (FIG. 5). The communication routing circuitry 510 determines that second serializer circuitry 1016 has an address of “4”.

At block 1208, the addressing scheme circuitry 502 identifies an output port of deserializer circuitry or aggregator circuitry storing a routing range including the address of the serializer circuitry. For example, the communication routing circuitry 510 uses the address of the connecting serializer circuitry to identify an output port of the deserializer circuitry to send the message through. The communication routing circuitry 510 determines that the first output port 1030 (FIG. 10) of the first deserializer circuitry 1002 (FIG. 10) stores routing range “1-8”, which includes address value “4”.

At block 1210, the addressing scheme circuitry 502 routes the communication to the endpoint device through the output port storing the routing range including the address of the serializer circuitry. For example, the communication routing circuitry 510 configures a message to be sent to the endpoint device based on routing it through the identified output port of the deserializer circuitry. For example, the communication routing circuitry 510 routes the communication to the endpoint device through the first output port 1030.

At block 1212, the addressing scheme circuitry 502 determines whether the communication has reached the endpoint device. For example, the communication routing circuitry 510 determines whether message has reached the endpoint device connected to the second serializer circuitry 1016. In FIG. 10, if the addressing scheme circuitry 502 determines that the message is at the first aggregator 1006 (e.g., block 1212 returns a value NO), control returns to block 1208 where the addressing scheme circuitry 502 identifies an output port of first aggregator circuitry storing the routing range including the address of the serializer circuitry.

At block 1212, when the addressing scheme circuitry 502 determines that the communication has reached the endpoint device (e.g., block 1212 returns a value YES), the operations 1200 end. For example, the operations 1200 end when the message reaches the endpoint device connected to the second serializer circuitry 1016. The operations 1200 may be repeated when the communication routing circuitry 510 initiates another communication to an endpoint device.

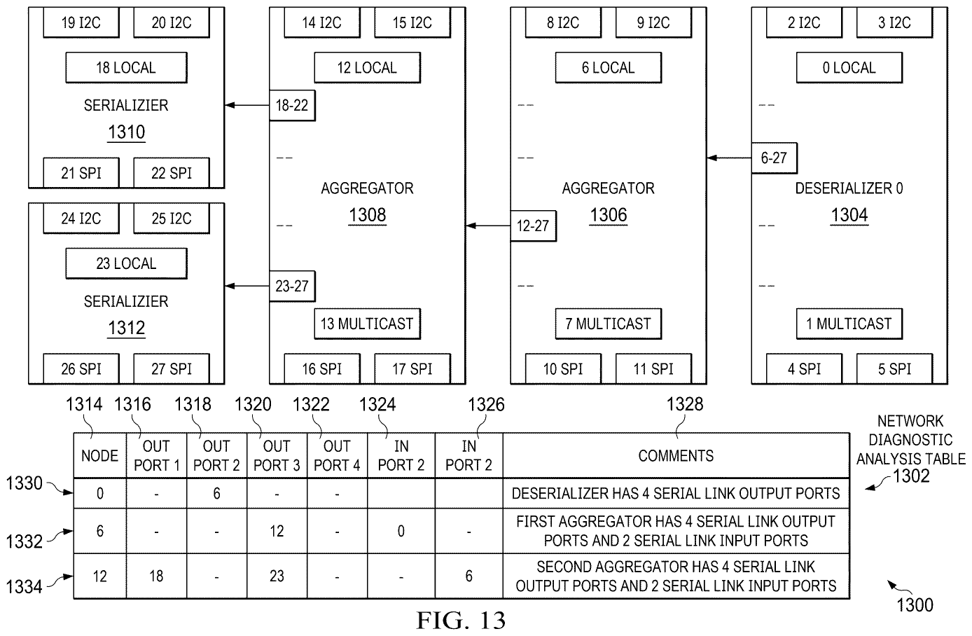

FIG. 13 is an example fifth serial link network 1300 including an example network diagnostic analysis table 1302. The fifth serial link network 1300 illustrates how the addressing scheme circuitry 502 assigns addresses to nodes and multicast tables. The fifth serial link network 1300 includes an example deserializer 1304, an example first aggregator 1306, an example second aggregator 1308, an example first serializer 1310, and an example second serializer 1312. The example first and second serializers 1310, 1312 may be connected to any type of endpoint device.

In FIG. 13, the deserializer 1304, the first aggregator 1306, the second aggregator 1308, the first serializer 1310, and the second serializer 1312 have two Inter-Integrated Circuit (I²C) ports and two Serial Peripheral Interface (SPI) ports. These ports are not serial link ports (e.g., FDP link ports) and, thus, do not store address ranges. However, the address determination circuitry 508 does store address values corresponding to respective child nodes connected to the I²C and SPI ports. While FIG. 13 does not illustrate the child nodes connected to each of the I²C ports and SPI ports, the address determination circuitry 508 has assigned address values, based on the number sequence and the order of identifying the child nodes, to the child nodes and stored those values in the respective ports of the parent node. For example, the node identifying circuitry 506 has determined that a first I²C port of the deserializer 1304 is connected to a child node assigned address value “2”, a second I²C port of the deserializer 1304 is connected to a child node assigned address value “3”, a first SPI port of the deserializer 1304 is connected to a child node assigned address value “4”, and a second SPI port of the deserializer 1304 is connected to a child node assigned address value “5”.

In FIG. 13, the node identifying circuitry 506 started identifying nodes and output ports at the primary root node: deserializer 1304. As such, the address determination circuitry 508 has assigned the deserializer 1304 the address value “0”. The node identifying circuitry 506 next identifies a first multicast table data register and the address determination circuitry 508 assigns a value “1” as the address of the first multicast table. As described above, the node identifying circuitry 506 next identifies the I²C ports and child nodes connected to the I²C ports, and the address determination circuitry 508 assigns values to I²C port child nodes. The node identifying circuitry 506 next identifies the SPI ports and child nodes connected to the SPI ports, and the address determination circuitry 508 assigns values to SPI port child nodes. Finally, the node identifying circuitry 506 analyzes serial link output ports of the deserializer 1304. In FIG. 13, the deserializer 1304 includes four serial link output ports, where the second of the four serial link output ports is connected to a child node but the first, third, and fourth serial link output ports are not connected to child nodes. Therefore, the node identifying circuitry 506 analyzes the second serial link output port of the deserializer 1304.

The node identifying circuitry 506 and the address determination circuitry 508 continue the process of the address program. For example, the node identifying circuitry 506 and the address determination circuitry 508 continue identifying a node, assigning the node with an address value, identifying whether the node has a multicast table and assigning the multicast table with an address value, identifying I²C ports and SPI ports of the node and assigning address values to their respective child nodes (and storing the same in memory of the respective ports), and then analyzing the serial link output ports of the node.

As a result, the communication routing circuitry 510 generates the network diagnostic analysis table 1302. For example, the communication routing circuitry 510 uses the address values and address ranges stored in memory of the output ports to generate a table that informs programmable circuitry 504 which devices are connected to which devices and at what ports they are connected. The network diagnostic analysis table 1302 includes a node column 1314, an output port 1 column 1316, an output port 2 column 1318, an output port 3 column 1320, an output port 4 column 1322, an in port 1 column 1324, an in port 2 column 1326, and a comments column 1328.

In the network diagnostic analysis table 1302, the communication routing circuitry 510 populates the columns 1314, 1316, 1318, 1320, 1322, 1324, 1326, and 1328 with address values, if appropriate. For example, the columns represent a serial link port of a selected node and indicate what node, if any, the serial link port is connected to. In a first row 1330, the node in the fifth serial link network 1300 with the address value “0” (e.g., deserializer 1304) is analyzed. The comments column 1328 notes that node 0 has four serial link ports and omits any mention of input ports. Therefore, in port 1 column 1324 and in port 2 column 1326 will not be populated in the first row 1330. In the first row 1330, the output port 1 column 1316 is not populated because the first serial link output port of the deserializer 1304 is not connected to any child node. In the first row 1330, the output port 2 column 1318 contains address value “6” indicating that the second serial link output port of the deserializer 1304 is connected to a child node having the address “6” (e.g., the first aggregator 1306). In the first row 1330, the output port 3 column 1320 and output port 4 column 1322 are not populated because the third and fourth serial link output ports of the deserializer 1304 are not connected to any child node.

In a second row 1332, the node in the fifth serial link network 1300 with the address value “6” (e.g., first aggregator 1306) is analyzed. The comments column 1328 notes that node 6 has four serial link ports and two serial link input ports. Therefore, depending on the configuration of the fifth serial link network 1300, in port 1 column 1324 and in port 2 column 1326 could be populated in the second row 1332 unlike in the first row 1330. In the second row 1332, output port 1 column 1316, output port 2 column 1318, and output port 4 column 1322 are not populated because the first, second, and fourth serial link output ports of the first aggregator 1306 are not connected to any child node. In the second row 1332, the output port 3 column 1320 contains address value “12” indicating that the third serial link output port of the first aggregator 1306 is connected to a child node having the address “12” (e.g., the second aggregator 1308). In the second row 1332, the in port 1 column 1324 contains address “0” because the first serial link input port of the first aggregator 1306 is connected to parent node 0 (e.g., the deserializer 1304). However, the in port 2 column 1326 is not populated in the second row 1332 because the second serial link input port of the first aggregator 1306 is not connected to any parent node.

In a third row 1334, the node in the fifth serial link network 1300 with the address value “12” (e.g., second aggregator 1308) is analyzed. The comments column 1328 notes that node 12 has four serial link ports and two serial link input ports, same as node 6. In the third row 1334, output port 2 column 1318 and output port 4 column 1322 are not populated because the second and fourth serial link output ports of the second aggregator 1308 are not connected to any child node. In the third row 1334, the output port 1 column 1316 contains address value “18” indicating that the first serial link output port of the second aggregator 1308 is connected to a child node having the address “18” (e.g., the first serializer 1310). The output port 3 column 1320 in the third row 1334 contains address value “23” indicating that the third serial link output port of the second aggregator 1308 is connected to a child node having the address “23” (e.g., the second serializer 1312). The in port 1 column 1324 is not populated in the third row 1334 because the first serial link input port of the second aggregator 1308 is not connected to any parent node. However, the in port 2 column 1326 contains address “6” because the second serial link input port of the second aggregator 1308 is connected to parent node 6 (e.g., the first aggregator 1306).

In some examples, the communication routing circuitry 510 uses the network diagnostic analysis table 1302 in response to not receiving an acknowledgement response from serializers or endpoint devices when sending messages to target serializers or endpoint devices. For example, if the communication routing circuitry 510 determines that no response was received from node 23 (e.g., the second serializer 1312), the communication routing circuitry 510 uses the network diagnostic analysis table 1302 to determine that serial link output port 3 of node 12 should be checked (e.g., scanned for any problems) and determine that serial link input port 2 of the node 12 should be checked. In some examples, the communication routing circuitry 510 notifies the programmable circuitry 504 to perform the check.

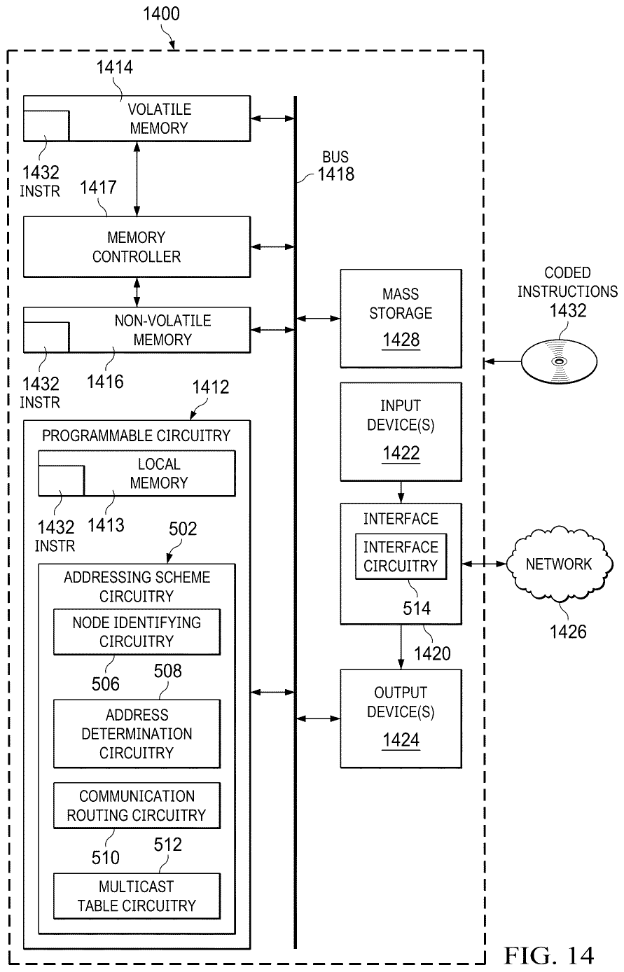

FIG. 14 is a block diagram of an example programmable circuitry platform 1400 structured to one or a combination of execute or instantiate one or more of the example machine-readable instructions or the example operations of FIGS. 9, 11, and 12 to implement the addressing scheme circuitry 502 of FIG. 5. The programmable circuitry platform 1400 can be, for example, a server, a personal computer, a self-learning machine (e.g., a neural network), or any other type of computing or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, or microcontrollers from any desired family or manufacturer. The programmable circuitry 1412 may be implemented by one or more semiconductor based (e.g., silicon based) devices. In this example, the programmable circuitry 1412 implements the example addressing scheme circuitry 502, the example node identifying circuitry 506, the example address determination circuitry 508, the example communication routing circuitry 510, and the example multicast table circuitry 512.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1416 may be implemented by one or a combination of flash memory or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter one of or a combination of data or commands into the programmable circuitry 1412. The input device(s) 1422 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1424 are also connected to the interface circuitry 1420 of the illustrated example. The output device(s) 1424 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), or speaker. The interface circuitry 1420 of the illustrated example, thus, includes one of or a combination of a graphics driver card, a graphics driver chip, or graphics processor circuitry such as a GPU.

The interface circuitry 1420 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1420 implements the interface circuitry 514.

The programmable circuitry platform 1400 of the illustrated example also includes one or more mass storage discs or devices 1428 to store one or more of firmware, software, or data. Examples of such mass storage discs or devices 1428 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1432, which may be implemented by the machine-readable instructions of FIGS. 9, 11, and 12, may be stored in one of or a combination of the mass storage device 1428, in the volatile memory 1414, in the non-volatile memory 1416, or on at least one non-transitory computer readable storage medium such as a CD or DVD which may be removable.

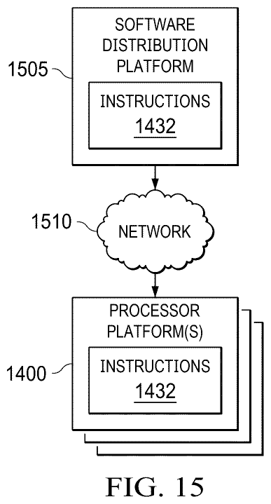

A block diagram illustrating an example software distribution platform 1505 to distribute software such as the example machine-readable instructions 1432 of FIG. 14 to other hardware devices (e.g., one or more hardware devices owned or operated by third parties from the owner or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity at least one of owning or operating the software distribution platform 1505. For example, the entity that at least one of owns or operates the software distribution platform 1505 may be at least one of a developer, a seller, or a licensor of software such as the example machine-readable instructions 1432 of FIG. 14. The third parties may be consumers, users, retailers, OEMs, etc., who one of or a combination of purchase or license the software for at least one of use, re-sale, or sub-licensing. In the illustrated example, the software distribution platform 1505 includes one or more servers and one or more storage devices. The storage devices store the machine-readable instructions 1432, which may correspond to the example machine-readable instructions of FIGS. 9, 11, and 12, as described above. The one or more servers of the example software distribution platform 1505 are in communication with an example network 1510, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third party payment entity. The servers enable one or more purchasers or licensors to download the machine-readable instructions 1432 from the software distribution platform 1505. For example, the software, which may correspond to the example machine-readable instructions of FIGS. 9, 11, and 12, may be downloaded to the example programmable circuitry platform 1400, which is to execute the machine-readable instructions 1432 to implement the addressing scheme circuitry 502. In some examples, one or more servers of the software distribution platform 1505 periodically at least one of offer, transmit, or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

While an example manner of implementing the addressing scheme circuitry 502 is illustrated in FIG. 5, one or more of the elements, processes, or devices illustrated in FIG. 5 may be combined, divided, re-arranged, omitted, eliminated, or implemented in any other way. Further, the example node identifying circuitry 506, the example address determination circuitry 508, the example communication routing circuitry 510, the example multicast table circuitry 512, the example interface circuitry 514, or, more generally, the example addressing scheme circuitry 502 of FIG. 5, may be implemented by hardware alone or by hardware in combination with software and firmware. Thus, for example, any of the example node identifying circuitry 506, the example address determination circuitry 508, the example communication routing circuitry 510, the example multicast table circuitry 512, the example interface circuitry 514, or, more generally, the example addressing scheme circuitry 502, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example addressing scheme circuitry 502 of FIG. 5 may include one or more elements, processes, or devices in addition to, or instead of, those illustrated in FIG. 5, or may include more than one of any or all of the illustrated elements, processes and devices.

Flowcharts representative of example machine-readable instructions, which may be executed by programmable circuitry to at least one of implement or instantiate the addressing scheme circuitry 502 of FIG. 5 or representative of example operations which may be performed by programmable circuitry to at least one of implement or instantiate the addressing scheme circuitry 502 of FIG. 5, are shown in FIGS. 9, 10, and 11. The machine-readable instructions may be one or more executable programs or portion(s) of one or more executable programs for execution by programmable circuitry such as the programmable circuitry 1412 shown in the example processor platform 1400 described below in connection with FIG. 14 and may be one or more function(s) or portion(s) of functions to be performed by example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9, 11, and 12, many other methods of implementing the example addressing scheme circuitry 502 may alternatively be used. For example, the order of execution of the blocks of the flowchart(s) may be changed, or some of the blocks described may be changed, eliminated, or combined. Also, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example operations of FIGS. 9, 11, and 12 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “or” when used, for example, in a form such as A, B, or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Modifications are possible in the embodiments described, and other embodiments are possible, within the scope of the claims.

From the foregoing, it will be appreciated that example systems, apparatus, articles of manufacture, and methods have been described that improve communication in a serial link network. For example, examples described herein provide an efficient addressing scheme that improves communication of control information and multicasting data to endpoint device by storing routing ranges in dedicated memory of serial link output ports in deserializers and aggregators that inform messages containing control information and multicasting data where to be routed. Examples described herein reduce bandwidth in serial link network communications during multicasting by replicating the multicast message at a parent device to the target devices, rather than at a source device which may be distances away from the target devices. Described systems, apparatus, articles of manufacture, and methods improve the efficiency of using a computing device by reducing an amount of processing at intermediate devices based on reducing an amount of cyclic redundancy checks (CRCs) needed to communication information to and from an endpoint device. Described systems, apparatus, articles of manufacture, and methods are also directed to one or more improvement(s) in the operation of a machine such as a computer or other electronic, electromechanical, or mechanical device.

What is claimed is:

1. An apparatus comprising:
interface circuitry; and
programmable circuitry configured to at least one of instantiate or execute machine-readable instructions to:
identify a root device in a serial link network, the root device having a first output port;
assign a first value as an address of the root device;
identify a second device in the serial link network that is coupled to the first output port of the root device, the second device having a second output port and a third output port;
assign a second value as the address of the second device;
identify a third device and a fourth device in the serial link network, the third device coupled to the second output port and the fourth device coupled to the third output port of the second device;
assign a third value as the address of the third device and a fourth value as the address of the fourth device; and
provide the second value and the fourth value, which represents a routing range, at the first output port of the root device.

2. The apparatus of claim 1, wherein the programmable circuitry is configured to use the routing range to communicate to any ones of the second device, third device, or fourth device.

3. The apparatus of claim 1, wherein the programmable circuitry is configured to exhaust a value as a candidate for a subsequent address of a device in the serial link network when the value is assigned as an address of a previous device.

4. The apparatus of claim 1, wherein the programmable circuitry is configured to:
provide the third value assigned to the third device to the second output port of the second device; and
provide the fourth value assigned to the fourth device to the third output port of the second device.

5. The apparatus of claim 1, wherein the programmable circuitry is configured to:
generate a multicast table to be stored in memory of the second device, the multicast table to include the third value assigned to the third device and the fourth value assigned to the fourth device;
assign a fifth value as an address of the multicast table; and
update the routing range at the first output port of the root device to replace the fourth value with the fifth value.

6. The apparatus of claim 1, wherein the second device includes a fourth output port and a fifth output port, the programmable circuitry is configured to:
identify a fifth device in the serial link network that is coupled to the fourth output port of the second device and a sixth device in the serial link network that is coupled to the fifth output port of the second device;
assign a fifth value as the address of the fifth device;
assign a sixth value as the address of the sixth device; and
update the routing range at the first output port to store the second value and the sixth value as the routing range.

7. The apparatus of claim 1, wherein the root device has a second output port and the routing range is a first routing range, the programmable circuitry is configured to:
identify a fifth device in the serial link network that is coupled to the second output port of the root device at a parent port of the fifth device, the fifth device having a fourth output port and a fifth output port;
assign a fifth value as the address of the fifth device;
identify a sixth device and a seventh device in the serial link network, the sixth device coupled to fourth output port and the seventh device coupled to the fifth output port;
assign a sixth value as the address of the sixth device and a seventh value as the address of the seventh device; and
provide the fifth value and the seventh value as a second routing range at the second output port of the root device.

8. A non-transitory machine-readable storage medium comprising instructions to cause programmable circuitry to at least:
identify a root device in a serial link network, the root device having a first output port;
assign a first value as an address of the root device;
identify a second device in the serial link network that is coupled to the first output port of the root device, the second device having a second output port and a third output port;
assign a second value as the address of the second device;
identify a third device and a fourth device in the serial link network, the third device coupled to the second output port and the fourth device coupled to the third output port of the second device;
assign a third value as the address of the third device and a fourth value as the address of the fourth device; and
provide the second value and the fourth value, which represents a routing range, at the first output port of the root device.

9. The non-transitory machine-readable storage medium of claim 8, wherein the instructions are to cause the programmable circuitry to use the routing range to communicate to any ones of the second device, third device, or fourth device.

10. The non-transitory machine-readable storage medium of claim 8, wherein the instructions are to cause the programmable circuitry to:
provide the third value assigned to the third device to the second output port of the second device; and
provide the fourth value assigned to the fourth device to the third output port of the second device.

11. The non-transitory machine-readable storage medium of claim 8, wherein the instructions are to cause the programmable circuitry to:
generate a multicast table to be stored in memory of the second device, the multicast table to include the third value assigned to the third device and the fourth value assigned to the fourth device;
assign a fifth value as an address of the multicast table; and
update the routing range at the first output port of the root device to replace the fourth value with the fifth value.

12. The non-transitory machine-readable storage medium of claim 8, wherein the second device includes a fourth output port and a fifth output port, and the instructions are to cause the programmable circuitry to:
identify a fifth device and a sixth device in the serial link network, the fifth device coupled to the fourth output port of the second device and the sixth device coupled to the fifth output port of the second device;
assign a fifth value as the address of the fifth device;
assign a sixth value as the address of the sixth device; and
update the routing range at the first output port to store the second value and the sixth value as the routing range.

13. The non-transitory machine-readable storage medium of claim 8, wherein the root device has a second output port and the routing range is a first routing range, and the instructions are to cause the programmable circuitry to:
identify a fifth device in the serial link network that is coupled to the second output port of the root device at a parent port, the fifth device having a fourth output port and a fifth output port;
assign a fifth value as the address of the fifth device;
identify a sixth device and a seventh device in the serial link network, the sixth device coupled to fourth output port and the seventh device coupled to the fifth output port;
assign a sixth value as the address of the sixth device and a seventh value as the address of the seventh device; and
provide the fifth value and the seventh value as a second routing range at the second output port of the root device.

14. The non-transitory machine-readable storage medium of claim 8, wherein the instructions are to cause the programmable circuitry to exhaust a value as a candidate for a subsequent address of a device in the serial link network when the value is assigned as an address of a previous device.

15. A system comprising:
a host device including programmable circuitry to configure an addressing scheme for the system;
a deserializer coupled to the host device and having at least one output port;
first and second intermediate devices connected in serial to the at least one output port, wherein the first and second intermediate devices have at least one output port and at least one input port;
a first endpoint device coupled to the second intermediate device at one of the at least one output port of the second intermediate device; and
wherein the programmable circuitry is configured to identify an order of the deserializer, first intermediate device, and second intermediate device from the host device to the first endpoint device and assign address values to the deserializer, first intermediate device, and second intermediate device based on the order, the address values to be used to generate an address range of the at least one output port of the deserializer.

16. The system of claim 15, wherein the at least one output port of the deserializer includes first memory to store the address range and the at least one output port of the first and second intermediate devices include second memory to store the address values.

17. The system of claim 15, wherein the address range includes a first address value in the order of first and second intermediate devices, and a last address value in the order of first and second intermediate devices, wherein the last address value is indicative of the second intermediate device that is coupled to the first endpoint device.

18. The system of claim 15, wherein the first intermediate device is aggregator circuitry and the second intermediate device is serializer circuitry.

19. The system of claim 15, wherein the at least one output port of the first and second intermediate devices include memory, wherein the memory is to store at least one address value based on a number of intermediate devices connected to the at least one output port.

20. The system of claim 15, wherein the first and second intermediate devices include data registers configured to store multicast tables, wherein the programmable circuitry is configured to assign address values to the data registers.

21. A method comprising:
identifying serializer circuitry connected to a sensor;
determining an address of the serializer circuitry;
identifying an output port of deserializer circuitry storing an address range including the address of the serializer circuitry; and
routing a message to the sensor through the output port.

22. The method of claim 21, wherein the deserializer circuitry is first deserializer circuitry, the output port is a first output port, and the address range is a first address range, the method further including:
determining that the first address range does not include the address of the serializer circuitry;
identifying intermediate circuitry coupled to the first deserializer circuitry;
determining that the intermediate circuitry includes a parent port connected to second deserializer circuitry, wherein the second deserializer circuitry includes a second output port storing a second address range including the address of the serializer circuitry; and
routing the message to the sensor through the parent port.

23. The method of claim 21, wherein the serializer circuitry is first serializer circuitry, the sensor is a first sensor, and the address is a first address, and further including:
generating a multicast message configured to be provided to the first sensor and a second sensor;
identifying second serializer circuitry coupled to the second sensor;
determining a second address of the second serializer circuitry;
determining a third address of a multicast table corresponding to the first serializer circuitry and the second serializer circuitry and including the first address and the second address;
determining that the output port of the deserializer circuitry stores the address range including the third address of the multicast table; and
routing the multicast message to intermediate circuitry storing the multicast table through the output port.

24. The method of claim 23, further including configuring the intermediate circuitry to replicate the multicast message to be routed to the first serializer circuitry and the second serializer circuitry.

25. The method of claim 23, further including:
configuring the first serializer circuitry and the second serializer circuitry to send acknowledgement responses to the multicast table; and
configuring the intermediate circuitry to combine the acknowledgement responses into an acknowledgement packet and route the acknowledgement packet to the deserializer circuitry.

26. The method of claim 21, wherein the serializer circuitry is first serializer circuitry and the sensor is a first sensor, further including:
receiving a request to communicate with a second sensor;
determining that the second sensor is inactive based on feedback from second serializer circuitry connected to the second sensor; and
ignoring the request to communicate with the second sensor.

27. The method of claim 21, wherein the serializer circuitry is first serializer circuitry, the sensor is a first sensor, and the address is a first address, further including:
receiving a request to communicate with a second sensor;
determining that the second sensor is inactive based on feedback from second serializer circuitry coupled to the second sensor; and
triggering an addressing scheme program to reconfigure addresses of a serial link network including the first sensor, the first serializer circuitry, the second sensor, and the second serializer circuitry, the reconfiguration to determine a new order of circuitry in the serial link network without the second serializer circuitry and assign update addresses to the circuitry based on the new order.
